(19) United States
(12) Patent Application Publication
(10) Pub. No.: US 2022/0250300 A1
(43) Pub. Date: Aug. 11, 2022

(54) Low-Pressure Molding System

(71) Applicant: Jes Tougaard GRAM, Georgetown (KY)

(72) Inventor: Jes Tougaard GRAM, Georgetown (KY)

(21) Appl. No.: 17/171,869

(22) Filed: Feb. 9, 2021

(51) Int. Cl. B29C 45/77; B29C 45/47; B29C 64/118; B33Y 30/00; B33Y 50/02

(52) U.S. Cl. CPC B29C 45/77; B29C 45/47; B29C 64/118; B33Y 30/00; B33Y 50/02; B29C 2945/76006; B29C 2945/76859; B29C 2945/76498; B29C 2945/76531; B29C 2945/7605; B29C 2945/7618; B29C 2945/76381; B29C 2945/7604

(57) ABSTRACT

The present invention relates to extrusion molding machines and methods of producing extrusion molded parts and, more particularly, to extrusion molding machines that adjust operating parameters of the extrusion molding machine during an extrusion molding run to account for changes in material properties and pressures of the extrusion material and methods of accounting for changes in extrusion molding material properties during an extrusion molding run and/or compounding of materials.

Disclosed herein is also a method of extrusion molding at low, substantially constant melt pressures. Embodiments of the disclosed method now make possible a method of extrusion that gives a better and more consistent product then a conventional extrusion process also resulting in a more energy and cost effective than conventional extrusion molding processes. Embodiments of the disclosed method surprisingly allow for the filling of an extrusion mold cavity at lower melt pressure and e.g. having a longer mold profile with cooling build in enabling a straighter and more consistent extruded profile with less sink and a more homogenic material composition.

Furthermore, it is possible that a constant pressure method could enable a better temperature control/profile of the plastic during the extrusion molding process.

Furthermore, a new innovative hot runner system having at least one cold runner portion in a mold component and/or mold part that is reheated during every molding cycle before injection of the next portion molten plastic material e.g. using conductive heating in whole or in part this heating form often having a short heating processes lasting for less than half a second.

### TECHNICAL FIELD OF THE INVENTION

The present invention relates to extrusion molding machines and methods of producing extrusion molded parts and, more particularly, to extrusion molding machines that adjust operating parameters of the extrusion molding machine during an extrusion molding run to account for changes in material properties and pressures of the extrusion material and methods of accounting for changes in extrusion molding material properties during an extrusion molding run and/or compounding of materials.

Disclosed herein is also a method of extrusion molding at low, substantially constant melt pressures. Embodiments of the disclosed method now make possible a method of extrusion that gives a better and more consistent product then a conventional extrusion process also resulting in a more energy and cost effective than conventional extrusion molding processes. Embodiments of the disclosed method surprisingly allow for the filling of an extrusion mold cavity at lower melt pressure and e.g. having a longer mold profile with cooling build in enabling a straighter and more consistent extruded profile with less sink and a more homogenic material composition.

Furthermore, it is possible that a constant pressure method could enable a better temperature control/profile of the plastic during the extrusion molding process.

Furthermore, a new innovative hot runner system having at least one cold runner portion in a mold component and/or mold part that is reheated during every molding cycle before injection of the next portion molten plastic material e.g. using conductive heating in whole or in part this heating form often having a short heating processes lasting for less than half a second.

### 1. Field of the Disclosure

The present disclosure relates to methods for extrusion molding, injection molding and blow molding, more particularly, to methods for extrusion molding at low, substantially constant melt pressures and controlling viscosity and melt temperature e.g. supported by pressure and shear heat measured before and/or after a breaker plate/plates placed in the extruder, injection unit and/or in a hot runner manifold where the size and geometry of the holes in the breaker plate/plates enables this e.g. combined with the breaker plate/plates being temperature controlled by heat and/or cooling and/or adjustable in flow hole size during the molding process. This novel process will also enhance the mixing of compounded materials as well as the separation of different/contaminated plastics e.g. in recycled plastics materials.

Furthermore, a new innovative hot runner system having at least one cold runner portion in a mold component and/or mold part that is reheated during every molding cycle before injection of the next portion molten plastic material e.g. using conductive heating in whole or in part this heating form often having a short heating processes lasting for less than half a second.

### 2. Brief Description of Related Technology that can be Improved by the Disclosed Inventions

Plastics extrusion is a high-volume manufacturing process in which raw plastic is melted and formed into a continuous profile. Extrusion produces items such as pipe/tubing, weather-stripping, fencing, deck railings window frames, plastic films and sheeting, thermoplastic coatings, and wire insulation.

This process starts by feeding plastic material (pellets, granules, flakes or powders) from a hopper into the barrel of the extruder. The material is gradually melted by the mechanical energy generated by turning screws and by heaters arranged along the barrel. The molten polymer is then forced into a die, which shapes the polymer into a shape that hardens during cooling.

In the extrusion of plastics, the raw compound material is commonly in the form of nurdles (small beads, often called resin) that are gravity fed from a top mounted material hopper into the barrel of the extruder. Additives such as colorants and UV inhibitors (in either liquid or pellet form) are often used and can be mixed into the resin prior to arriving at the hopper. The process has much in common with plastic injection molding from the point of the extruder technology, although it differs in that it is usually a continuous process. While pultrusion can offer many similar profiles in continuous lengths, usually with added reinforcing, this is achieved by pulling the finished product out of a die instead of extruding the polymer melt through a die.

The material enters through the feed throat (an opening near the rear of the barrel) and comes into contact with the screw. The rotating screw (normally turning at e.g. 120 rpm) forces the plastic beads forward into the heated barrel. The desired extrusion temperature is rarely equal to the set temperature of the barrel due to viscous heating and other effects. In most processes, a heating profile is set for the barrel in which three or more independent PID-controlled heater zones gradually increase the temperature of the barrel from the rear (where the plastic enters) to the front. This allows the plastic beads to melt gradually as they are pushed through the barrel and lowers the risk of overheating which may cause degradation in the polymer.

Extra heat is contributed by the intense pressure and friction taking place inside the barrel. In fact, if an extrusion line is running certain materials fast enough, the heaters can be shut off and the melt temperature maintained by pressure and friction alone inside the barrel. In most extruders, cooling fans are present to keep the temperature below a set value if too much heat is generated. If forced air cooling proves insufficient then cast-in cooling jackets are employed.

At the front of the barrel, the molten plastic leaves the screw and travels through a screen pack to remove any contaminants in the melt. The screens are reinforced by a breaker plate (a thick metal puck with many holes drilled through it) since the pressure at this point can exceed 5,000 psi. The screen pack/breaker plate assembly also serves to create back pressure in the barrel. Back pressure is required for uniform melting and proper mixing of the polymer, and how much pressure is generated can be “tweaked” by varying screen pack composition (the number of screens, their wire weave size, and other parameters). This breaker plate and screen pack combination also eliminates the “rotational memory” of the molten plastic and creates instead, “longitudinal memory”.

Breaker plates are essentially required in extruders to cover filter screens and provide uniform melting and mixing of the polymer before entering the extrusion mold. The number of holes, the diameter of the holes and the thickness of the breaker plates has a direct impact on the time required for the forming process.

The use of breaker plates in the extrusion process serve a dual purpose, i.e., create a seal between the extruder barrel and, secondly, allow a means of building back pressure through the use of screen packs.

However, sometimes deleterious effects take place because the screen are too fine and filter out some of the compound ingredients causing back pressure to escalate during the course of a production run.

The remedy is to design a breaker plate with the same surface, i.e., smaller holes and less of them to achieve the same back pressure without screens!

Optimized breaker plates can be design with maximized number of holes e.g. of different sizes. Providing different hole configurations for a given break plate geometry, the optimized design can be evaluated for stress distribution and deformation under different molding/extrusion conditions in different plastic materials and/or compounded plastic materials homogeneities/consistency in output.

The edge to edge thickness between the successive holes was also crucial, to avoid excessive deformation due to stress generation. With consecutive iterations considering the different parameters, three optimized breaker plate designs were proposed possessing maximum number of holes as well as maintaining the stress and deformation values within the allowable limits.

After passing through the breaker plate molten plastic enters the extrusion mold. The mold is what gives the final product its profile and must be designed so that the molten plastic evenly flows from a cylindrical profile, to the product's profile shape. Uneven flow at this stage can produce a product with unwanted residual stresses at certain points in the profile which can cause warping upon cooling. A wide variety of shapes can be created, restricted to continuous profiles.

The product must now be cooled, and this is usually achieved by pulling the extrudate through a water bath. Plastics are very good thermal insulators and are therefore difficult to cool quickly. Compared to steel, plastic conducts its heat away 2,000 times more slowly. In a tube or pipe extrusion line, a sealed water bath is acted upon by a carefully controlled vacuum to keep the newly formed and still molten tube or pipe from collapsing. For products such as plastic sheeting, the cooling is achieved by pulling through a set of cooling rolls. For films and very thin sheeting, air cooling can be effective as an initial cooling stage, as in blown film extrusion.

Plastic extruders are also extensively used to reprocess recycled plastic waste or other raw materials after cleaning, sorting and/or blending. This material is commonly extruded into filaments suitable for chopping into the bead or pellet stock to use as a precursor for further processing.

Normally there are five possible zones in a thermoplastic screw. Since terminology is not standardized in the industry, different names may refer to these zones. Different types of polymer will have differing screw designs, some not incorporating all of the possible zones.

Most screws have these three zones:
Feed zone (also called the solids conveying zone): this zone feeds the resin into the extruder, and the channel depth is usually the same throughout the zone.
Melting zone (also called the transition or compression zone): most of the polymer is melted in this section, and the channel depth gets progressively smaller.
Metering zone (also called the melt conveying zone): this zone melts the last particles and mixes to a uniform temperature and composition. Like the feed zone, the channel depth is constant throughout this zone.

In addition, a vented (two-stage) screw has:
Decompression zone. In this zone, about two-thirds down the screw, the channel suddenly gets deeper, which relieves the pressure and allows any trapped gases (moisture, air, solvents, or reactants) to be drawn out by vacuum.
Second metering zone. This zone is similar to the first metering zone, but with greater channel depth. It serves to re-pressurize the melt to get it through the resistance of the screens and the die.

Often screw length is referenced to its diameter as L:D ratio. For instance, a 6-inch (150 mm) diameter screw at 24:1 will be 144 inches (12 ft) long, and at 32:1 it is 192 inches (16 ft) long. An L:D ratio of 25:1 is common, but some machines go up to 40:1 for more mixing and more output at the same screw diameter. Two-stage (vented) screws are typically 36:1 to account for the two extra zones.

Each zone is equipped with one or more thermocouples in the barrel wall for temperature control. The “temperature profile” i.e., the temperature of each zone is very important to the quality and characteristics of the final extrudate.

Typical plastic materials that are used in extrusion include but are not limited to: polyethylene (PE), polypropylene, acetal, acrylic, nylon (polyamides), polystyrene, polyvinyl chloride (PVC), acrylonitrile butadiene styrene (ABS) and polycarbonate.

The manufacture of plastic film for products such as shopping bags and continuous sheeting is achieved using a blown film line.

This process is the same as a regular extrusion process up until the die. There are three main types of dies used in this process: annular (or crosshead), spider, and spiral. Annular dies are the simplest and rely on the polymer melt channeling around the entire cross section of the die before exiting the die; this can result in uneven flow. Spider dies consist of a central mandrel attached to the outer die ring via a number of “legs”; while flow is more symmetrical than in annular dies, a number of weld lines are produced which weaken the film. Spiral dies remove the issue of weld lines and asymmetrical flow but are by far the most complex.

The melt is cooled somewhat before leaving the die to yield a weak semi-solid tube.

This tube's diameter is rapidly expanded via air pressure, and the tube is drawn upwards with rollers, stretching the plastic in both the transverse and draw directions. The drawing and blowing cause the film to be thinner than the extruded tube, and also preferentially aligns the polymer molecular chains in the direction that sees the most plastic strain. If the film is drawn more than it is blown (the final tube diameter is close to the extruded diameter) the polymer molecules will be highly aligned with the draw direction, making a film that is strong in that direction, but weak in the transverse direction. A film that has significantly larger diameter than the extruded diameter will have more strength in the transverse direction, but less in the draw direction.

In the case of polyethylene and other semi-crystalline polymers, as the film cools it crystallizes at what is known as the frost line. As the film continues to cool, it is drawn through several sets of nip rollers to flatten it into lay-flat tubing, which can then be spooled or slit into two or more rolls of sheeting.

Sheet/film extrusion is used to extrude plastic sheets or films that are too thick to be blown. There are two types of dies used: T-shaped and coat hanger. The purpose of these dies is to reorient and guide the flow of polymer melt from a single round output from the extruder to a thin, flat planar flow. In both die types ensure constant, uniform flow across the entire cross-sectional area of the die. Cooling is typically by pulling through a set of cooling rolls. In sheet extrusion, these rolls not only deliver the necessary cooling but also determine sheet thickness and surface texture. Often co-extrusion is used to apply one or more layers on top of a base material to obtain specific properties such as UV-absorption, texture, oxygen permeation resistance, or energy reflection.

A common post-extrusion process for plastic sheet stock is thermoforming, where the sheet is heated until soft (plastic) and formed via a mold into a new shape. When vacuum is used, this is often described as vacuum forming. Orientation (i.e. ability/available density of the sheet to be drawn to the mold which can vary in depths from 1 to 36 inches typically) is highly important and greatly affects forming cycle times for most plastics.

Extruded tubing, such as PVC pipes, is manufactured using very similar dies as used in blown film extrusion. Positive pressure can be applied to the internal cavities through the pin, or negative pressure can be applied to the outside diameter using a vacuum sizer to ensure correct final dimensions. Additional lumens or holes may be introduced by adding the appropriate inner mandrels to the die.

Multi-layer tubing applications are also ever present within the automotive industry, plumbing & heating industry and packaging industry.

Over jacketing extrusion allows for the application of an outer layer of plastic onto an existing wire or cable. This is the typical process for insulating wires.

There are two different types of die tooling used for coating over a wire, tubing (or jacketing) and pressure. In jacketing tooling, the polymer melt does not touch the inner wire until immediately before the die lips. In pressure tooling, the melt contacts the inner wire long before it reaches the die lips; this is done at a high pressure to ensure good adhesion of the melt. If intimate contact or adhesion is required between the new layer and existing wire, pressure tooling is used. If adhesion is not desired/necessary, jacketing tooling is used instead.

Coextrusion is the extrusion of multiple layers of material simultaneously. This type of extrusion utilizes two or more extruders to melt and deliver a steady volumetric throughput of different viscous plastics to a single extrusion head (die) which will extrude the materials in the desired form. This technology is used on any of the processes described above (blown film, over-jacketing, tubing, sheet). The layer thicknesses are controlled by the relative speeds and sizes of the individual extruders delivering the materials.

In many real-world scenarios, a single polymer cannot meet all the demands of an application. Compound extrusion allows a blended material to be extruded, but coextrusion retains the separate materials as different layers in the extruded product, allowing appropriate placement of materials with differing properties such as oxygen permeability, strength, stiffness, and wear resistance.

Co-extrusion can also be defined as the process in which two or more plastic materials are extruded through a single extrusion mold. In this process, two or more orifices are arranged in such a manner that the conjoint merging and welding of the extrudates takes place and before chilling, a laminar structure form. In co-extrusion, a separate extruder is used to fed every material to the extrusion mold but the orifices can be arranged in such a manner that each extruder provides two or more plies of the same material.

Co-extrusion may be employed in the processes of Film Blowing, Extrusion Coating, and Free Film Extrusion. The general benefit of the co-extrusion process is that every laminate ply imparts a required characteristic property like heat-sealability, stiffness, & impermeability, all of which are impossible to attain by using any single material.

It is evident that co-extrusion is a better process than a single layer extrusion. For instance, in the vinyl fencing industry, co-extrusion process is used for tailoring the layers on the basis of whether these are exposed to weather or not. Generally, compound's thin layer is extruded that contains high-priced weather resistant additives. This extrusion is done on the outside, whereas inside there is an additive package which is more suitable for the structural performance and impact resistance.

### Advantages of Co-Extrusion

According to various internationally established and popular companies that are using the co-extrusion process continuously in their production procedures, there are a number of advantages of this process. Some of these advantages are listed below:
High quality mono-layer extrusion coatings in larger varieties of line speeds and widths
Use of lower cost materials for filling purpose, assists in saving on the amount of qualitative resins
Capability of making multi-layer as well as multi-functional structures that too in a single pass
Reduction in the number of steps required in general extrusion process
Provides targeted performance with the use of definite polymers in particular layers
Reduction in setup and trim scrap
Potential for use of a recycle layer

### Disadvantages of Co-Extrusion

As per a number of globally reckoned companies, there are some disadvantages related with the process of co-extrusion. Some of these disadvantages are as follows:
Minor differences in physical properties are responsible for making a combination desirable, but these differences are also responsible for making the combination incompatible
For this process, polymers must have similar melt viscosities to sustain a laminar flow. All the viscosity differences may be more or less tolerable, according to the material location inside the composite structure along with the layer's thinness
Requires more sophisticated extruder and its operator. This implies extra maintenance cost of the equipment.
Demands considerable planning as well as forethought in the system design

Extrusion coating is using a blown or cast film process to coat an additional layer onto an existing roll-stock of paper, foil or film. For example, this process can be used to improve the characteristics of paper by coating it with polyethylene to make it more resistant to water. The extruded layer can also be used as an adhesive to bring two other materials together.

Compounding extrusion is a process that mixes one or more polymers with additives and/or fillers to give plastic compounds. Additive and/or filler materials can affect the tensile strength, toughness, heat resistance, color, clarity etc. A good example of this is the addition of talc to polypropylene. Most of the filler materials used in plastics are mineral or glass-based filler materials. There are two main subgroups of filler materials: particulates and fibers. Particulates are small particles of filler which are mixed in the matrix where size and aspect ratio are important. Fibers come in many forms and often in small circular strands that can be very long and have very high aspect ratios. The feeds may be pellets, powder and/or liquids, but the compounded product is usually in pellet form, to be used in other plastic-forming processes such as extrusion and injection molding. As with traditional extrusion, there is a wide range in machine sizes depending on application and desired throughput. While either single- or double-screw extruders may be used in traditional extrusion, the necessity of adequate mixing in compounding extrusion makes twin-screw extruders all but mandatory.

There are two sub-types of twin-screw extruders: co-rotating and counter-rotating. This nomenclature refers to the relative direction each screw spins compared to the other. In co-rotation mode, both screws spin either clockwise or counter-clockwise; in counter-rotation, one screw spins clockwise while the other spins counterclockwise. It has been shown that, for a given cross sectional area and degree of overlap (intermeshing), axial velocity and degree of mixing is higher in co-rotating twin extruders. However, pressure buildup is higher in counter-rotating extruders. The screw design is commonly modular in that various conveying and mixing elements are arranged on the shafts to allow for rapid reconfiguration for a process change or replacement of individual components due to wear or corrosive damage.

Injection Molding

The injection unit of injection molding machine is much like an extruder. The injection unit melts the polymer resin and injects the polymer melt into the mold. It consists of a barrel that is fed from one end by a hopper containing a supply of plastic pellets. The unit may be: ram fed or screw fed.

The injection unit consists of a granulate hopper, cylinder, screw, nozzle, heating bands and hydraulic drives and serves the purpose of melting and injecting the molding material.

A nozzle shut-off valve used in an injection molding machine for plastic. By opening and closing the shut-off valve with the pressure of plastic from or in the injection unit. An aspect relates to an improved nozzle shut-off valve for use in reciprocating screw or plunger type injection molding machines of the kind used to handle plastic and elastomeric material.

Conventional molding apparatus of the reciprocating rotating screw type usually includes a plasticizing cylinder or chamber having a bore, wherein the plasticizing screw rotates in such a manner so as to allow the solid molding material to enter the cylinder and be plasticized as it advances in the direction of screw feed. Attached on one end of the plasticizing cylinder is a nozzle in communication with a mold sprue which leads to the mold cavity. As the plasticized material is deposited at the metering or front end of the screw, it develops a back pressure that forces the screw to retract in the cylinder bore and when the plasticized material reaches a predetermined volume, or shot size, the retracting screw contacts a limit switch and stops its rotation. The shot is now ready for injection into the mold cavity, generally upon receipt of a signal from the clamp, whereupon the screw is driven forward hydraulically and/or electrically to inject the shot. Later, the plasticizing screw again starts to rotate and gradually retract as a new shot is built up in the plasticizing cylinder. Thus, the screw reciprocates once per machine cycle to plasticize and inject a shot of material.

Often, a shut-off valve is employed to interrupt the flow of molten material from the nozzle into the mold sprue. The valve offers the advantages of minimizing or entirely curtailing drool through cut off of material flow at the nozzle and provide the capability to plasticize during periods in which the mold is open. Generally, plasticizing takes place during part curing to prevent plasticized material from escaping.

The force to open a nozzle shut-off valve preparatory to an injection cycle by various arrangements of hydraulic motor, pneumatic piston and cylinder arrangements, and the location and orientation of the several parts.

The shut-off valve/valves can also be placed in the mold at the individual cavity/cavities in a valve gate hot runner system.

A hot runner system is an assembly of heated components—hot halves, nozzles and gates and—that inject plastic into the cavities of an injection mold. The system usually includes a heated manifold and a number of heated nozzles. The manifold distributes the plastic entering the mold to the nozzles, which then meter it precisely to the injection points in the cavities. The hot runner is equipped with its own temperature control system called a hot runner controller.

A hot runner controller is a temperature controller used to control the temperature in the hot runner. This helps create the most consistent part(s) due to the ability to modify the temperature at the individual gate location thereby enabling a balanced fill of the cavity/cavities.

By contrast, a cold runner is simply a channel formed between the two halves of the mold, for the purpose of carrying plastic from the injection molding machine nozzle to the cavities. Each time the mold opens to eject the newly formed plastic parts, the material in the runner is ejected as well, resulting in waste.

A hot runner system usually includes a heated manifold and a number of heated nozzles. The main task of the manifold is to distribute the plastic entering the mold to the various nozzles which then meter it precisely to the injection points in the cavities.

Hot runner systems are fairly complicated systems, they have to maintain the plastic material within them heated uniformly, while the rest of the injection mold is being cooled in order to solidify the product quickly.

Hot runners usually make the mold more expensive to manufacture and run, but they allow savings by reducing plastic waste and by reducing the cycle time because you don't have to wait until the conventional runners freeze.

Hot Runner Advantages
Shorter cycle time: No runner controlling the cooling time
Easier to start: Without runners to remove, and auto cycle occurs faster and more frequently
Fewer sink marks and under-filled parts: Unlike when plastic flows through a cold runner and loses heat to mold plates
Design flexibility: Can locate the gate at many points on the part
Balanced melt flow: Separate melt channels are in externally heated manifolds that are insulated from mold plates surrounding them.

From a technical point of view, valve gate technology enables the production of low-stress injection molding parts, which almost always meet the requirements of a very low vestige. As a result, the lower degree of stress when gating with valve gate systems becomes relevant. When using a valve gate there is no need to control the vestige by trying to achieve small gate diameters. Small gate diameters of course lead to higher shear rates and therefore inevitably result in a higher degree of orientation. Areas with a high degree of orientation cause internal stress, so warping of the part is a high risk. For example, a gate diameter of 0.8 mm for a part with a shot weight of 10 g results in a local shear rate of approximately 150,000 1/s. When a valve gate with a needle diameter of 2.5 mm is used, the shear rate in the gate area is approximately 6,000 1/s.

Safety is another factor to consider when using valve gate systems. For example, valve gate systems are used to avoid stringing in fast cycling molds. Stringing always occurs when the melt in the gate has no chance to freeze properly within the time given. This can happen in fast-cycling molds as well as with large gate diameters or with an improper temperature control. With valve gate technology, stringing can be avoided in most cases. The mechanical shut-off ensures that the gate is always sealed properly, regardless of the gating diameter. However, in case of very large needle diameters, even valve gate systems can cause problems. When operating with short cycle times the needle stores so much heat during injection that a bonding effect in the needle area can occur.

Using valve gates also provides a processing improvement gained by the precise control of the shut-off time. When molding multi-point gated parts, the formation of flow lines can be avoided by a sequential opening of the needles. By using this method, a controlled melt flow can be achieved so that a frontal meeting of flow fronts can either be avoided or be placed in less critical areas of the part.

Valve Gate System Gating Variations

Two important sealing principles have been established for the processing of thermoplastics with valve gate systems. One of them is the conical needle geometry. During closing the conical needle moves into corresponding gate geometry in the mold insert. When using this principle, the closing power of the needle drive must be limited to avoid damage of the mold insert. When the needle closes the melt is displaced from the narrowing gap.

In lieu of the conical needle, the cylindrical form is often used. Here the mold insert normally has a conical entrance leading into a short cylindrical bore. The melt in the cylindrical area, which measures only some tenth of a millimeter, must be pushed into the part when closing the needle. Considering the low melt volume and the shrinkage, this normally has no effect on the molded part.

Needles protruding from the side into the gate on an angle offer some advantages because the melt flow is only slightly blocked in their open position. However, because the non-symmetrical layout of this gating method causes a higher wear, this method has not gained a large market acceptance.

Valve Gate System with Integrated Needle Drive

An in-line valve gate with an integrated needle drive is a general-purpose system compared to standard designs. Due to the construction of the nozzles, the valve gate can be handled like a “conventional” hot runner system. As shown in the description regarding function and mounting location, a fixed mold half consists of a normal clamping plate, a manifold frame plate including a standard manifold and a nozzle retainer plate. The in-line valve gate can be used as a freestanding single tip as well. There is no need for any changes in construction. Examples for applications are shown in.

When used in stack molds, the in-line valve gate offers decisive advantages. Since there is no need to place the needle drive behind the manifold and to guide the needle through the manifold, a perfectly symmetrical positioning of the cavities can be achieved. This means optimal utilization of mold and machine. Furthermore, two in-line valve gate nozzles that are positioned exactly opposite each other can be used for a central leakage-free melt-transfer in stack molds without having to use an accumulator cavity.

In large molds with deeply immersed nozzles, very long needles must be used. At the same time, the nozzles are screwed into the manifold. To ensure that the desired position of the needle is reached when the manifold is heated up and thermally expanded, the needle must be adapted while the system is cold or jamming of the needle and wear in the needle guides is possible. This problem can be eliminated by using a valve gate system with an integrated needle drive as the final stage of a long nozzle. The position of the valve gate is fixed within the mold and a flexible pipe connects the valve gate to the manifold. Due to the fact that the needle is contained within the valve gate assembly, it experiences smaller growth and is not affected by other elements such as manifold growth.

Standard Valve Gate

The standard valve gate is of importance when a low system height is required. Because the needle drive is positioned in the clamping plate, the total height of the system is similar to a normal hot runner system. However, when using this method, the manifold of the hot runner system must be specially adjusted to the valve gate system. Either additional sealing elements or at least clearance bores for the needle must be provided. The clearance bores must be positioned so that they do not interfere with the melt channels in the manifold. An in-line valve gate nozzle with a needle drive that can be operated mechanically, hydraulically or pneumatically is useful in this situation.

Valve Gate for Multi-Component Applications

The coaxial valve gate was developed using the principles of the standard valve gate. This technology allows the injection of two components via one injection point. The components may be injected both at the same time or delayed. Considering the mold technology, the following layer configurations are possible: inner/outer or outer/inner layers (simple layers) or outer/inner/outer layers (sandwich). The possibility of using the sandwich method for direct gating in a multi-cavity mold especially opens up a wide range of applications. For example, the production of pre-forms with barrier layer or the production of parts with thick walls (foamed core component to counterbalance shrinking) is possible. The use of materials with different structures for the inner and outer layer helps to create special haptical appearances.

In addition, the coaxial valve gate is suitable for partial hot runner solutions as well. For example, there are different methods that it can be used as a machine nozzle. The first one is the application as a “universal single nozzle” within an additional machine plate. This configuration allows the production of sandwich parts by using standard two-component machines in combination with conventional runner solutions (three-plate molds). In this case, the part as well as the cold runner system must have sufficient dimensions because due to the so-called “sandwich plate,” a large portion of the mold daylight width cannot be utilized.

This problem is eliminated when using a two-component machine nozzle. In this case, a machine with special configurations must be used because both injection units must be connected with the coaxial valve gate nozzle. The coaxial valve gate system facilitates the injection of both components simultaneously. Adjusting the simultaneous phase of the injection cycle can vary the penetration of the core component. With a machine configuration as mentioned above, both injection units could be used independently for standard injection molding. For articles that must be molded in two different colors, the color change can be accomplished with only one shot.

Of course, two-component molding can be done with “conventional” valve gate systems as well. One of the methods normally used is the transfer method, requiring a rotary table or a handling system. The other method is the core-back method. Both are seldom used for layer configurations but mainly for production of articles with additional sealing lips, grip-areas and two-colored areas positioned next to each other or injected polymer windows.

“Hot runner” is a term used in injection molding that refers to the system of parts that are physically heated such that they can be more effectively used to transfer molten plastic from a machine's nozzle into the various mold tool cavities that combine to form the shell of your part. Sometimes they are called “hot sprues.” You can contrast the term “hot runner” with its opposite, and the historically more common “cold runner.” Cold runners are simply an unheated, physical channel that is used to direct molten plastic into a mold tool cavity after it leaves the nozzle. The primary difference is that hot runners are heated while cold runners are not.

While hot runners are not required for injection molding processes, they can be useful to ensure a higher quality part. They are particularly beneficial with challenging part geometries that require lower margin of error in the flow properties of the molten plastic (i.e. where inopportune cooling or temperature deltas might result in uneven flow). Further, hot runners can be beneficial in reducing wasted plastic during high volume shoots. Because cold runners are unheated, the channel needs to be larger and thus more plastic needs to be shot during each cycle. If you are shooting a large number of parts while iterating to get the design correct you could easily run up the cost of plastic above the cost of a hot runner assembly. The downside to hot runner technology, is that it is more expensive by default than a cold runner setup.

The advantage of hot runners is that, if designed properly, the plastic will flow from the machine's nozzle more uniformly into the gate locations. Agate location is the point at which molten plastic enters the cavity of the injection mold. Gate location, plastic temperature, the design of internal mold cavities, and the material properties of the plastic itself e.g. regrind/recycled material that will preform different than virgin material as well as that of the mold all have an important impact on the success or failure of the injection molding process.

Hot runners are designed to maximize manufacturing productivity by reducing cycle time. Internally heated hot runner designs resulted in solidified plastic on the internal boundaries of the channel with molten plastic much more localized to the specific heater location. By contrast, externally heated runners utilize heated nozzles and a heated manifold and based on the high thermal conductivity of metal they are able to maintain much more even flow properties for the internal plastic.

Externally heated: This system design employs a cartridge-heated manifold with interior flow passages. To separate it from the rest of the mold, the manifold has several insulating characteristics that reduce heat loss. Since it does not require a heater that can block the flow, and all of the plastic is molten, the externally heated hot runner channels have the lowest pressure drop of any runner system. This method works better for color changes because none of the colors in the runner system freeze. In addition, materials do not have surfaces where they stick to and degrade—an attribute that makes externally heated systems an excellent choice for thermally sensitive materials.

Internally heated: Internally heated runner systems have annulus flow passages that are heated by a probe and torpedo located in the passages. Taking advantage of the insulating effect of the rubber melt, it reduces heat loss to the rest of the mold. However, this system requires higher molding pressures, and color changes can be quite challenging. In addition, materials have many places where they stick to the surface and degrade. You should not use thermally sensitive materials in the fabrication process.

Heating the runner can be done through a variety of materials, including coils, cartridge heaters, heating rods, heating pipes and band heaters. A complex control system ensures a consistent flow and distribution of the melt.

Insulated runners. Unheated, this type of runner requires extremely thick runner channels to stay molten during continuous cycling. These molds have extra-large passages formed in the mold plate. During the fabrication process, the size of the passages in conjunction with the heat applied with each shot results in an open molten flow path. This inexpensive system eliminates the added cost of the manifold and drops but provides flexible gates of a heated hot runner system. It allows for easy color changes.

A three-plate mold is used when part of the cold runner system is on a different plane to the injection location. The runner system for a three-plate mold sits on a second parting plane parallel to the main parting plane. This second parting plane enables the runners and sprue to be ejected when the mold is opened

Injection Screw

The reciprocating-screw machine is the most common. This design uses the same barrel for melting and injection of plastic.

When the mold is closed the screw by its rotation moves the plastic forward filling a predeterminate volume in front of the screw while moving backwards until this volume is achieved and then stops its rotation. When the empty mold then is closed, and the screw is the used as a plunger injecting the warm plastic into the empty mold holding the filled mold cavity under pressure until the plastic has solidified. After a predetermined cooling time the mold is opened and the solidified plastic part in the mold is ejected and the mold closes again, and the process repeats itself.

The alternative unit involves the use of separate barrels for plasticizing and injecting the polymer. This type is called a screw-preplasticizer machine or two-stage machine. Plastic pellets are fed from a hopper into the first stage, which uses a screw to drive the polymer forward and melt it. This barrel feeds a second barrel, which uses a plunger to inject the melt into the mold. Older machines used one plunger-driven barrel to melt and inject the plastic. These machines are referred to as plunger-type injection molding machines.

Selecting Injection Molding Screws

Using the right injection molding screws is crucial to making quality parts consistently and with maximum production output.

To select the right screw, details of the particular part to be molded must be known (that is, part material, weight, size and wall thickness). The basic mold design is also important so that flow length from gate, shot weight and runner system are all taken into consideration.

Choosing a screw without knowledge of the parts is like buying a car without any preference for performance and handling requirements.

The basic design of any screw has 3 zones along its length:

1 Feed zone

2. Transition zone

3. Metering zone

The feed zone conveys the solid plastic pellets which are fed from the hopper to the transition zone where they are compressed by a change in screw geometry. This compression forces the pellets to melt through the action of pushing up against each other. This is called shearing. The metering zone then conveys the melt to the front of the screw ready for injection into the mold cavity.

In the transition zone the material is compressed by the change in the depth of the screw channels from the feed zone to the metering zone. The ratio of the change in depth is called the compression ratio and is usually between 2 and 3 for plastics such as PP and PE. The length of the transition zone is typically 4 to 7× the screw diameter in a general-purpose screw.

Another aspect of screw design is the length to diameter ratio (L/D) meaning how long it is compared to its diameter. As an example, the L/D ratio for PP and PE is in the range 20-30:1.

When it comes to general purpose screws, longer screws are usually preferred because they will produce a better-quality melt and therefore produce better quality parts

The advantage of a general-purpose screw is that they can be used with most plastic materials such as PP, PE, Nylon, PET and PC so they are very flexible and good for molding companies that mold a variety of different materials.

The disadvantage is that, for some materials, part quality and productivity rates will be lower compared to more advanced injection molding screw designs such as the barrier screw.

This type of screw provides a better-quality melt at a faster rate compared with a general-purpose screw. There are many different designs of barrier screws, the difference being in the varying of the flight depths and channel widths.

The exact design chosen must be in line with the application.

Although double flight screws have a different design, they are an alternative to barrier screws. They are also designed to deliver a high-quality melt at fast rates.

The design ensures the plastic is fully melted before it reaches the compression zone, which is not the case in a general-purpose screw.

Double flight injection molding screws can be used in technical parts for PP and thin wall technical parts in PA which does not plasticize well with barrier screws.

The screw diameter is important for 2 reasons. The first reason is that it determines the maximum available injection pressure, the smaller the diameter the higher the available pressure. This is critical for parts that have thin walls and a long flow length and for plastic materials that are difficult to inject.

The second reason is the diameter determines the maximum shot size available. The smaller the diameter, the smaller the shot size.

It can be seen that there is a conflict between shot size and injection pressure when selecting a screw diameter. Initially it might seem advantageous to choose the largest diameter so that there is more flexibility in the types and size of parts that can be made in one machine, but this is the wrong way to think about it.

The screw diameter should be chosen in line with the application otherwise quality and/or productivity rates will suffer. The injection unit must be capable of generating enough injection pressure (with some in reserve) to maintain consistent fill times and as a consequence, maintain the quality.

Serious thought should be given to using a heat-treated screw and barrel as these will provide longer life than non-heat-treated parts. This is especially important when the material contains some level of reinforcement as this is much more abrasive and will wear out the screw and barrel sooner than material without reinforcement.

Once the screw and barrel start to wear, part quality will start to suffer, and it will only be a matter of time before a replacement will be needed. This is a large cost, not just because of the cost of the replacement screw but for the loss in production.

The tip is a non-return valve at the front of the screw which allows the melt to pass through during the plasticizing stage but stops the melt from back flowing into the screw during the injection stage.

There are 2 basic designs the ball check valve and the sliding ring check valve. The ring check valve is generally preferred because it allows an easier path for the melt to pass through compared to a ball check valve. Therefore, a ring check valve is suited to shear sensitive materials such PC.

However, the disadvantage of the ring valve is their tendency to wear, so the ring check valve condition should be checked on a regular basis. A typical sign of wear is inconsistent cushioning during processing.

The fact is, in today's competitive environment, injection molding manufacturers need to be making parts as efficiently as possible in order to keep manufacturing costs down and delivery times short.

Using the right injection molding screws for your parts will play a significant role in this.

Plasticizing Cylinder

Screw position at the end of the dosage process; the plasticized material is in front of the screw tip. Screw position after the injection process; the plasticized material is injected into the mold. A material cushion is left in front of the screw for injection into the mold during the holding pressure phase.

Blow molding is a specific manufacturing process by which hollow plastic parts are formed and can be joined together. It is also used for forming glass bottles or other hollow shapes.

In general, there are three main types of blow molding: extrusion blow molding, injection blow molding, and injection stretch blow molding.

The blow molding process begins with melting down the plastic and forming it into a parison or, in the case of injection and injection stretch blow molding (ISB), a preform. The parison is a tube-like piece of plastic with a hole in one end through which compressed air can pass.

The parison is then clamped into a mold and air is blown into it. The air pressure then pushes the plastic out to match the mold. Once the plastic has cooled and hardened the mold opens up and the part is ejected. The cost of blow molded parts is higher than that of injection-molded parts but lower than rotational molded parts.

In extrusion blow molding, plastic is melted and extruded into a hollow tube (a parison). This parison is then captured by closing it into a cooled metal mold. Air is then blown into the parison, inflating it into the shape of the hollow bottle, container, or part. After the plastic has cooled sufficiently, the mold is opened, and the part is ejected. Continuous and Intermittent are two variations of Extrusion Blow Molding. In continuous extrusion blow molding the parison is extruded continuously and the individual parts are cut off by a suitable knife. In Intermittent blow molding there are two processes: straight intermittent is similar to injection molding whereby the screw turns, then stops and pushes the melt out. With the accumulator method, an accumulator gathers melted plastic and when the previous mold has cooled and enough plastic has accumulated, a rod pushes the melted plastic and forms the parison. In this case the screw may turn continuously or intermittently. With continuous extrusion the weight of the parison drags the parison and makes calibrating the wall thickness difficult. The accumulator head or reciprocating screw methods use hydraulic systems to push the parison out quickly reducing the effect of the weight and allowing precise control over the wall thickness by adjusting the die gap with a parison programming device.

Containers such as jars often have an excess of material due to the molding process. This is trimmed off by spinning a knife around the container which cuts the material away. This excess plastic is then recycled to create new moldings. Spin Trimmers are used on a number of materials, such as PVC, HDPE and PE+LDPE. Different types of the materials have their own physical characteristics affecting trimming. For example, moldings produced from amorphous materials are much more difficult to trim than crystalline materials. Titanium coated blades are often used rather than standard steel to increase life by a factor of 30 times.

The process of injection blow molding is used for the production of hollow glass and plastic objects in large quantities. In the injection blow molding process, the polymer is injection molded onto a core pin; then the core pin is rotated to a blow molding station to be inflated and cooled. This is the least-used of the three different blow molding processes and is typically used to make small medical and single serve bottles. The process is divided into three steps: injection, blowing and ejection.

The injection blow molding machine is based on an extruder barrel and screw assembly which melts the polymer. The molten polymer is fed into a hot runner manifold where it is injected through nozzles into a heated cavity and core pin. The cavity mold forms the external shape and is clamped around a core rod which forms the internal shape of the preform. The preform consists of a fully formed bottle/jar neck with a thick tube of polymer attached, which will form the body. similar in appearance to a test tube with a threaded neck.

The preform mold opens and the core rod is rotated and clamped into the hollow, chilled blow mold. The end of the core rod opens and allows compressed air into the preform, which inflates it to the finished article shape.

After a cooling period the blow mold opens, and the core rod is rotated to the ejection position. The finished article is stripped off the core rod and as an option can be leak-tested prior to packing. The preform and blow mold can have many cavities, typically three to sixteen depending on the article size and the required output. There are three sets of core rods, which allow concurrent preform injection, blow molding and ejection.

Compression Molding is a method of molding in which the molding material, generally preheated, is first placed in an open, heated mold cavity. The mold is closed with a top force or plug member, pressure is applied to force the material into contact with all mold areas, while heat and pressure are maintained until the molding material has cured. The process employs thermosetting resins in a partially cured stage, either in the form of granules, putty-like masses, or preforms.

Compression molding is a high-volume, high-pressure method suitable for molding complex, high-strength fiberglass reinforcements. Advanced composite thermoplastic can also be compression molded with unidirectional tapes, woven fabrics, randomly oriented fiber mat or chopped strand. The advantage of compression molding is its ability to mold large, fairly intricate parts. Also, it is one of the lowest cost molding methods compared with other methods such as transfer molding and injection molding; moreover, it wastes relatively little material, giving it an advantage when working with expensive compounds.

However, compression molding often provides poor product consistency and difficulty in controlling flashing, and it is not suitable for some types of parts. Fewer knit lines are produced and a smaller amount of fiber-length degradation is noticeable when compared to injection molding. Compression-molding is also suitable for ultra-large basic shape production in sizes beyond the capacity of extrusion techniques.

Compression molding was first developed to manufacture composite parts for metal replacement applications, compression molding is typically used to make larger flat or moderately curved parts. This method of molding is greatly used in manufacturing automotive parts such as hoods, fenders, scoops, spoilers, as well as smaller more intricate parts. The material to be molded is positioned in the mold cavity and the heated platens are closed by a hydraulic ram. Bulk molding compound or sheet molding compound are conformed to the mold form by the applied pressure and heated until the curing reaction occurs. SMC feed material usually is cut to conform to the surface area of the mold. The mold is then cooled, and the part removed.

Materials may be loaded into the mold either in the form of pellets or sheet, or the mold may be loaded from a plasticizing extruder. Materials are heated above their melting points, formed and cooled. The more evenly the feed material is distributed over the mold surface, the less flow orientation occurs during the compression stage.

Compression molding is also widely used to produce sandwich structures that incorporate a core material such as a honeycomb or polymer foam.

Thermoplastic matrices are commonplace in mass production industries. One significant example are automotive applications where the leading technologies are long fiber reinforced thermoplastics and glass fiber mat reinforced thermoplastics.

In compression molding there are six important considerations that an engineer should bear in mind.
Determining the proper amount of material.
Determining the minimum amount of energy required to heat the material.
Determining the minimum time required to heat the material.
Determining the appropriate heating technique.
Predicting the required force, to ensure that shot attains the proper shape.
Designing the mold for rapid cooling after the material has been compressed into the mold.

Extruders for 3D Printing

Types of Extruders Depending on the Drive

Within extruders there are two types depending on the type of drive: Direct and Bowden. In the direct extruder, as its name suggests, the filament runs directly from the cog of the extruder to the HotEnd. There are even systems in which these two parts are together.

In the Bowden extruders, on the contrary, the connection with the HotEnd is through a

PTFE tube through which the filament passes.

The main function of the extruder is to move the filament from the reel to the HotEnd in the most precise way and at the speed suitable for 3D printing.

Types of Extruders: Direct

The direct extruder, as its name suggests, the filament runs directly from the cog of the extruder to the HotEnd. There are even systems in which these two parts are together, as in the Titan Aero.

The direct extruders allow the printing of rigid and flexible materials (1.75 mm and 2.85 mm) regardless of the composition of the filament. Another advantage is that they require low retraction lengths, reducing printing time and increasing the extruder motor life. Its main drawback is the inertias produced in the axis of the printer in which the extruder moves, caused by the weight and unbalance of the center of mass with respect to the axis. Another drawback can appear in closed printers and with a tempered chamber that can reach temperatures in the extruder motor that affect the performance of operation.

Types of Extruders: Bowden

In the Bowden extruders, on the contrary that the direct extruders, the union with the HotEnd is through a PTFE tube through which the filament passes.

These extruders have low inertias in the axis of displacement of the HotEnd. The Bowden system, since the extruder and the extruder motor are anchored to the chassis of the 3D printer, greatly reduce the inertias in the movement to make the impression. This makes it possible to produce very fast prints and at the same time of high quality. Its main disadvantage is the great difficulty to print flexible filaments (TPE) of diameter 1.75 mm. This is due to the fact that being a flexible filament it is not possible to keep the pressure in the filament constant along the Bowden PTFE tube until the HotEnd, since it flexes the filament. In Bowden systems of 2.85 mm however it is possible to print the flexible filaments at low speed.

Direct Extruders

Advantages:

Print flexible materials, both PLA Soft or TPU, and TPE in 1.75 mm and 2.85 mm.

Print all kinds of materials without problems, regardless of the abrasion presented by certain filaments. To print 3D abrasive materials, it is recommended using a brass nozzle with the ruby tip that has an almost infinite life.

This system needs short retraction lengths to obtain good 3D prints, which reduces the likelihood of a jam.

Retraction is the recoil movement of the filament necessary to prevent dripping of material during movements and displacements that the vacuum extruder performs during 3D printing.

The parameters that configure the retraction are:
Retraction distance: Length of material that recedes in the retraction process. It varies depending on the type of material, the type of extrusion system Direct or Bowden and the type of HotEnd. For flexible materials, especially for the TPE type, retraction must be deactivated to prevent the filament from coiling on the extruder pinion.
Retraction speed: Speed at which the extruder motor drives back the filament. With this parameter it's necessary to be very careful if high speeds are used (greater than 70 mm/s) because it can mark the filament in such a way that it's unusable to continue the 3D printing.

Disadvantages:

Considerable inertia in the axis through which the extruder and the HotEnd moves. This factor is increased when you want to make 3D prints at high speeds by having to move the weight of the whole set (extruder, extruder motor and HotEnd), especially if the 3D printer has several extruders.

Temperature problems in the electric motor of the extruder. In closed 3D printers and with a tempered chamber, temperatures in the extruder motor can be reached that affect the performance of operation.

Bowden Extruders

Advantages:

Low inertias in the axis of displacement of the HotEnd. In the Bowden system, since the extruder and the extruder motor are anchored to the chassis of the 3D printer, the inertias in the movement to make the impression are greatly reduced. This allows for very fast and high-quality printing.

High drag power of the filament. The majority of 3D printers that use this extruder system have a set of pinions (reducer group) that increases the drag torque of the filament, thus being able to move coils larger than normal.

Disadvantages:

Problems printing with flexible filaments with a diameter of 1.75 mm. This is due to the fact that being a flexible filament it isn't possible to keep the pressure in the filament constant along the Bowden PTFE tube until the HotEnd as it channels the filament. In the 2.85 mm Bowden systems, however, it's possible to print the flexible filaments at low speed.

Types of HotEnd Depending on the Diameter of the Material

The HotEnd is responsible for melting the filament to make the desired piece. It configures the type of HotEnd (V6 or Volcano) and the nozzle depending on the diameter of the material, depending on the type of piece, quality and finish you want to obtain. We classify the extruders in the V6 and Volcano types and then we mention the advantages and disadvantages between these two types of HotEnd.

Advantages and Disadvantages of HotEnd V6

Advantages:

The V6 is the most versatile HotEnd on the market, valid for all types of impressions, even for flexible materials (especially with 2.85/3 mm filament). With the HotEnd V6 you can make all kinds of parts with an exceptional finishing quality.

Disadvantages:

The maximum diameter of nozzle recommended for this type of extruder is 0.80 mm/1 mm since for larger diameters, problems of continuity of flow usually occur.

Advantages and Disadvantages of HotEnd Volcano

Advantages:

Thanks to the parallel position of the Heater Cartridge with respect to the nozzle, a greater heated area is achieved, thus giving great control and stability over the melting of the filament. For all the above you can make 3D prints with larger diameter nozzle (1.2 mm), which leads to shorter manufacturing times and the possibility of printing with a higher layer height than in the V6.

More resistant pieces. Thanks to making higher layers with a laminar flow (without bubbles) the joints between the chemical bonds of the material are stronger, giving more rigid and resistant parts.

Disadvantages:

Surface finish of low detail. Due to the high layer heights, the pieces are made with steps in areas where there are curved surfaces at different heights.

Understanding Viscosity in Extrusion

Both the power-law coefficient and the consistency index must be considered to calculate viscosity.

Viscosity for non-Newtonian polymers is a combination of increasing temperature and shear rate, as described by the following relationship:

η=mγⁿ⁻¹

where viscosity (η) equals consistency index (m) times the shear rate (γ) to the power law index (n) minus 1.

Generally, only rheology experts discuss the effects of the consistency index. The consistency index, or viscosity change with increasing temperature, is largely dependent on the energy input to the polymer by shear from the screw rotation. That is, as the shearing raises the polymer temperature by viscous dissipation or conversion of mechanical power to temperature, the viscosity additionally decreases due to the higher temperature and adds to the shear thinning. The consistency index describes that rate of decrease due to increased temperature.

The shear-thinning characteristics of various polymers are often categorized solely by the power-law coefficient, but the consistency index can have just as significant effect on the final viscosity and has to be considered.

As a result, two polymers of similar melt index or melt flow can have vastly different viscosities at the elevated shear rates during processing. Melt-index and melt-flow measurements by capillary rheometer are at very low shear rates, where shear thinning is almost non-existent. Due to the multiplying effect of power-law coefficient and consistency index, an HDPE and a PP at identical shear rates and slightly different temperatures can have a difference in viscosity where the HDPE is three times as viscous as the PP. This means that the melt temperature of the HDPE on the same screw design is going to be much higher than the PP.

Use of the simple viscosity calculation can greatly assist in analysis of extruder power requirements, melt temperature and polymer flow for different polymers without the use of shear-rate/viscosity graphs

Interestingly, some polymers can reach a near autogenous or adiabatic shear rate where the viscosity drops proportional to the shear rate or screw speed such that further heating through viscous dissipation is minimized and the power-requirement increases only a small amount.

The actual calculation of the motor load using the calculated viscosity is quite complicated and generally requires computer simulation. However, the calculated viscosity can be a useful tool for approximation of the viscosity and the resulting screw power requirements when coupled with the calculations for viscous dissipation of different polymers on single-screw extruders of different sizes and L/D ratios. Power-law coefficient and consistency data can be found on the internet or from the polymer suppliers.

Viscosity: Definition

Viscosity as it relates to plastic injection is the measurement of how thick or thin a material flow. A good comparison would be the difference between molasses and water. If you were to pour water and molasses at the same time, water would flow much easier than the molasses. Molasses is thick and flows slowly. Water is thinner and flows much faster. Molasses would be considered to be high viscosity, and water would be low viscosity.

The same terminology applies in different plastic injection materials. Materials that are low viscosity flow thin and quick, while high viscosity materials flow thick and slower. For instance, nylon flows thinner and faster than styrene, thus nylon has a lower viscosity than styrene. Styrene falls in the middle of the material scale and is considered to be the mean. As such, materials that are at a higher viscosity than styrene are recorded as positive. Materials that are a lower viscosity than styrene are recorded in MSDS data as negative values.

Viscosity vs. Temperature

Temperature plays an important role in adjusting viscosity. The general rules of thumb are this:
Adding heat will lower the viscosity of a material, thus making the flow thinner and faster. It is important to note here that higher temperatures add to cycle time, and that there is a point when temperature becomes detrimental by producing more gas and causing degradation. Melt temperature should be measured to assure that barrel temperature is within the tolerances of the melt window provided by the machine manufacturer.
Reducing heat thickens the flow and slows down the fill rate. Lower temperatures provide faster cycle times but increase wear on plastics equipment if the temperature becomes too low. Again, it is important to measure melt temperature to verify that heats are within the melt window.

Viscosity Vs. Fill Time

Viscosity has little effect on fill time. Thinner flow fronts flow easier, however injection speed is established through scientific procedure to be at the mean of slow to fast. The press controls the speed using valves, servos, etc. There is, however, a change in the amount of energy used to satisfy what set points establish as the correct fill speed. Increased energy usage can sometimes result in higher production cost, and vice versa for energy decreases. There are situations where one or the other may become more beneficial based on higher production needs or value costing.

Viscosity Vs. Peak Pressure

Viscosity also has a direct relationship to peak pressure. A thicker, cooler flow front will result in a higher peak pressure. A thinner, warmer flow front results in a lower peak pressure. Thus, adding heat lowers viscosity and peak pressure while reducing heat increases viscosity and peak pressure.

Using Viscosity to Address Defects

This section will address several common molding defects and list methods of using viscosity changes to improve part quality. At no point does this article theorize that viscosity is the cure all for molding defects, but there are situations where adjusting viscosity can improve part functions and/or appearance. Listed here are many of these situations, and methods of using viscosity to improve upon or eliminate the defect:

Sink:

There are several different types of sink, but heat sink and sinks over ribs or deep contours in the mold design can have a direct relationship to viscosity.
Heat sink—Heat sink occurs when mold or material temperature are too hot. Cycle time can also be a factor. In some instances, lowering barrel temperature can reduce or eliminate heat sink conditions.
Sink over ribs/details: Sinks over ribs can be related to two different situations:
1. Material in the rib can still be too hot, leading to a sink over the rib. In this case, lowering viscosity may improve the condition by lowering heat in the rib area.
2. Sink can also be caused by material flowing across the rib too slow, leading to an over pack condition that causes a pull sink as the part ejects. In this situation, increasing heat can promote thinner flow, flowing faster across the rib and packing it out less. As the part ejects, the rib being packed less allows for better removal of the part.

Flash:

There are several situations where flash can be directly attributed to viscosity. For instance, hair line flash can be a sure sign that material is too viscous, and a temperature reduction is needed to improve the condition. In some situations where a mold has parting line damage, reducing heat can actually improve flash that was a direct result of that damage.

Knit Lines:

Knit lines occur when different flow fronts come together as plastic flows through the part cavities. In the case of mold details, knits will occur on the lee side of a detail. Picture a rock in a stream. as the water rushes against it, the rock causes resistance. The water flows around the rock, knitting back together as the two flow fronts meet each other in the rear the faster the water flows, the longer it takes for the two flow streams to reassemble as one. The same applies when molding around a detail. Faster flow results in longer thinner knits. Slower flow results in thicker and shorter knits. In terms of viscosity, higher heat equals faster flow and lower heat equals slower flow. If packing around a detail is causing cracks/shorts/burns on the knit line, reduce the heat to improve knit line seal and strength.

As noted above, there are many situations where viscosity can be used as a tool to correct poor molding conditions. When standardizing process, start off with lower level viscosity as determined by melt temperature, and then make adjustments using higher temperatures when viscosity appears to be directly related to molding issues. This assures that cycle times are optimal, thus leading to higher efficiency. Low scrap and high efficiency will lead to higher returns off of your molded products.

Plastic recycling is the process of recovering scrap or waste plastic and reprocessing the material into useful products. Since the majority of plastic is non-biodegradable, recycling is a part of global efforts to reduce plastic in the waste stream, especially the approximately 8 million metric tons of waste plastic that enters the Earth's ocean every year.

Compared with lucrative recycling of metal, and similar to the low value of glass recycling, plastic polymers recycling is often more challenging because of low density and low value. There are also numerous technical hurdles to overcome when recycling plastic. Materials recovery facilities are responsible for sorting and processing plastics but have struggled to do so economically as of 2019.

When different types of plastics are melted together, they tend to phase-separate, like oil and water, and set in these layers. The phase boundaries cause structural weakness and delamination in the resulting material, meaning that polymer blends are useful in only limited applications. The two most widely manufactured plastics, polypropylene and polyethylene, behave this way, which limits their utility for recycling. Each time plastic is recycled, additional virgin materials must be added to help improve the integrity of the material. So, even recycled plastic has new plastic material added in. The same piece of plastic can only be recycled about 2-3 times before its quality decreases to the point where it can no longer be used.

Centrifugation

One of the most common pieces of equipment used to separate materials into subfractions in a biochemistry lab is the centrifuge. A centrifuge is a device that spins liquid samples at high speeds and thus creates a strong centripetal force causing the denser materials to travel towards the bottom of the centrifuge tube more rapidly than they would under the force of normal gravity.

Induction Heating is an Accurate, Fast, Repeatable, Efficient, Non-Contact Technique for Heating Metals or any Other Electrically Conductive Materials.

An induction heating system consists of an induction power supply for converting line power to an alternating current and delivering it to a workhead, and a work coil for generating an electromagnetic field within the coil. The work piece is positioned in the coil such that this field induces a current in the work piece, which in turn produces heat.

The water-cooled coil is positioned around or bordering the work piece. It does not contact the work piece, and the heat is only produced by the induced current transmitted through the work piece. The material used to make the work piece can be a metal such as copper, aluminum, steel, or brass. It can also be a semiconductor such as graphite, carbon or silicon carbide.

For heating non-conductive materials such as plastics or glass, induction can be used to heat an electrically conductive susceptor e.g., graphite, which then passes the heat to the non-conducting material.

Induction heating finds applications in processes where temperatures are as low as 100° C. (212° F.) and as high as 3000° C. (5432° F.). It is also used in short heating processes lasting for less than half a second and in heating processes that extend over several months.

Induction heating is used both domestic and commercial cooking, in several applications such as heat treating, soldering, preheating for welding, melting, shrink fitting in industry, sealing, brazing, curing, and in research and development.

How does Induction Heating Work?

Induction produces an electromagnetic field in a coil to transfer energy to a work piece to be heated. When the electrical current passes along a wire, a magnetic field is produced around that wire.

Key Benefits of Induction

The benefits of induction are:
Efficient and quick heating
Accurate, repeatable heating
Safe heating as there is no flame
Prolonged life of fixturing due to accurate heating

Methods of Induction Heating

Induction heating is done using two methods:

The first method is referred to as eddy current heating from the I²R losses caused from the resistivity of a work piece's material. The second is referred to as hysteretic heating, in which energy is produced within a part by the alternating magnetic field generated by the coil modifying the component's magnetic polarity.

Hysteretic heating occurs in a component up to the Curie temperature when the material's magnetic permeability decreases to 1 and hysteretic heating is reduced. Eddy current heating constitutes the remaining induction heating effect.

When there is a change in the direction of electrical current (AC) the magnetic field generated fails, and is produced in the reverse direction, as the direction of the current is reversed. When a second wire is positioned in that alternating magnetic field, an alternating current is produced in the second wire.

The current transmitted through the second wire and that through the first wire are proportional to each other and also to the inverse of the square of the distance between them.

When the wire in this model is substituted with a coil, the alternating current on the coil generates an electromagnetic field and while the work piece to be heated is in the field, the work piece matches to the second wire and an alternating current is produced in the work piece. The I²R losses of the material resistivity of the work piece causes heat to be created in the work piece of the work piece's material resistivity. This is called eddy current heating.

Plastics processors today encounter many barriers to an autonomous injection molding operation. This is because the levers that control the stability of the operation are often varying in ways that are either difficult, or in some cases impossible, for the processor to control. Overcoming these challenges requires: 1) a robust process that can withstand the normal variations in materials, mold, machine, and environment; and 2) a control system that can intelligently adapt to the variations that are outside

The iMFLUX Technology:

Works by controlling the filling process by actual plastic pressure filling and packing the mold using a low and constant plastic pressure. The key to making the process work is a proprietary control system that eliminates flow hesitations, packs the part as it fills, and reduces pressure loss within the mold. This allows plastic to flow much slower than conventional processing techniques, and results in a process with lower pressure, shorter cycle time, and the ability to adapt in real time as molding conditions vary.

iMFLUX controls the filling process by maintaining plastic pressure at a lower, and more constant pressure. In so doing, the process is inherently less susceptible to variations that shut down a conventional process.

The reason the process is so robust is that it actively controls plastic pressure during molding, which is the number-one factor impacting the quality and consistency of an injection molded plastic part. This overcomes the inconsistency of conventionally controlled processing where screw velocity is maintained constant, but plastic pressure varies as material and molding conditions change. When it comes to autonomous molding, the iMFLUX technology is steering the process based on what really matters—plastic pressure—a massive advantage.

iMFLUX can adapt the process to handle variations, even variations well outside of the normal range, much easier than can be achieved with a conventional process. This is possible because the iMFLUX is a simple process, essentially pressure and time. On traditional injection molding, adapting to changes requires modifying several variables—injection velocity, transfer position (or cavity pressure), holding pressure, and holding time. What's more, the holding time itself must accommodate variations that have complex interactions.

The iMFLUX technology, adjustments are limited essentially to plastic pressure (how much pressure is driving the plastic in to the mold) and time (how long is this pressure applied). The simplicity of the process enables iMFLUX to create highly advanced control algorithms that can handle variations well beyond what is practical on the conventional injection molding technology.

The ability to reliably process variable materials is one of the industry's biggest needs, since processors are being asked to run more and more recycled and lower-cost materials. Often these materials have varying viscosity, making them very difficult to handle. Conventional injection molding is set up to run parts at a static set of process conditions, and as even relatively small material variations occur, process adjustments are needed to maintain part quality. Recent advances in technology have made it easier to manage material variations on conventional injection molding, however, that process is still inherently unstable due to its sensitivity to transfer position and pressure. The iMFLUX technology is much less susceptible to such changes, since it has no transfer position and adjusts in real time to variations in material rheology.

Blocked Cavities:

A traditional molding process is set to inject a certain volume of plastic into a mold, regardless of the ability of the mold to accept this volume. This can create issues if a gate becomes blocked, or if a part is not ejected completely, leaving nowhere for the plastic to go. Depending on the number of mold cavities and cavity volumes, this will result in bad parts and potential damage to the mold.

The iMFLUX technology works differently, since it is continuously controlling the process and monitoring plastic pressure. If a mold cavity becomes blocked, the system immediately recognizes this change and profiles the injection velocity to match what is needed for the current state of the mold. Not only does this prevent tool damage, the process actually makes good-quality parts in the remaining cavities. Similar to automated braking on your car, the system understands when to slow the movement of the screw to optimally fill the cavity. This feature is particularly helpful with multicavity molds where the processor needs to keep a mold running at less than full cavitation. In this case, the mold cavities can simply be turned off without the need to develop a new modified process. This is not possible in conventional injection molding.

Leaky Check-Rings & Worn Barrels:

Consistent check-ring functioning is necessary with traditional velocity-based process control to maintain a consistent polymer volume at transfer. Even small variations can cause big issues with part quality. Using the iMFLUX technology, a leaking check ring has virtually no impact on the process, since the process is completely reliant on plastic pressure with real-time feedback. If the check ring leaks, iMFLUX simply accelerates the screw to compensate for the leakage. Conventional injection molding relies on static process settings and cannot make dynamic adjustments for inconsistent check-ring performance. Using iMFLUX technology these adjustments is not necessary, as long as the press can build plastic pressure, a completely repeatable process can be obtained. This is true whether the repeatability issues are consistent shot-to-shot, or sporadic in nature. To achieve truly autonomous molding the process must be able to adapt to these kinds of common variations, or it cannot be effective in achieving a stable, repeatable process.

An advanced feature released by iMFLUX earlier this year, called Auto-Viscosity Adjust (AVA), enables the iMFLUX technology to manage even larger variations than the base iMFLUX technology. The new feature can handle viscosity shifts of ±50 MFI or more. AVA works by detecting viscosity changes, then modifying filling pressure to achieve the same filling time shot-to-shot. The process adjusts in real time without needing operator input. This is true regardless of the source of variation, which can include regrind variation, percentage of regrind, colorant changes, moisture level of the material, or temperature variation. Basically, if the machine can melt it, the iMFLUX technology can process it.

Another feature just released enables the control system to compensate for material density shifts, even shot-to-shot. Called Precision Shot, the technology works by first building shot pressure to a predetermined threshold, followed by metering the shot into the mold. This feature is only possible when controlling the process using plastic melt pressure, enabling the system to accurately determine that the check ring has seated and that the target compression of the melt has been achieved.

### BRIEF DESCRIPTION OF THE DRAWINGS

The embodiments set forth in the drawings are illustrative and exemplary in nature and not intended to limit the subject matter defined by the claims:

FIG. 1 illustrates a diagrammatic front view of a plastic extrusion machine according to one or more embodiments shown and described herein;

FIG. 2 is a illustration of a breaker plate for extrusion molding at low, substantially constant pressure in accordance with an embodiment of the disclosure;

FIG. 3 is a illustration of a blow molding machine for molding at low, substantially constant pressure in accordance with another embodiment of the disclosure;

FIG. 4 is a schematic illustration of a parison entering a blow mold;

FIG. 5 is a schematic illustration of a bottle blow mold process for molding at low, substantially constant pressure in accordance with another embodiment of the disclosure;

FIG. 6 illustrates a diagrammatic front view of a plastic injection molding machine according to one or more embodiments shown and described herein;

FIG. 7 illustrates a diagrammatic front view of a hot runner mold that could be improved by the method of injection molding at low, substantially constant pressure in accordance with an embodiment of the disclosure;

FIG. 8 illustrates a diagrammatic front view of a more detailed hot runner mold;

FIG. 9 illustrates a diagrammatic view of the iMFLUX low-pressure process molding thick-to-thin-to-thick in this PP demo part. This application requires automatic control software and sensors that provide absolutely constant filling pressure, with no hesitation enabling a 0.030 inch. Diameter runner having a 3-inch long “filament” portion before entering and filling the cavity of the part without freezing.

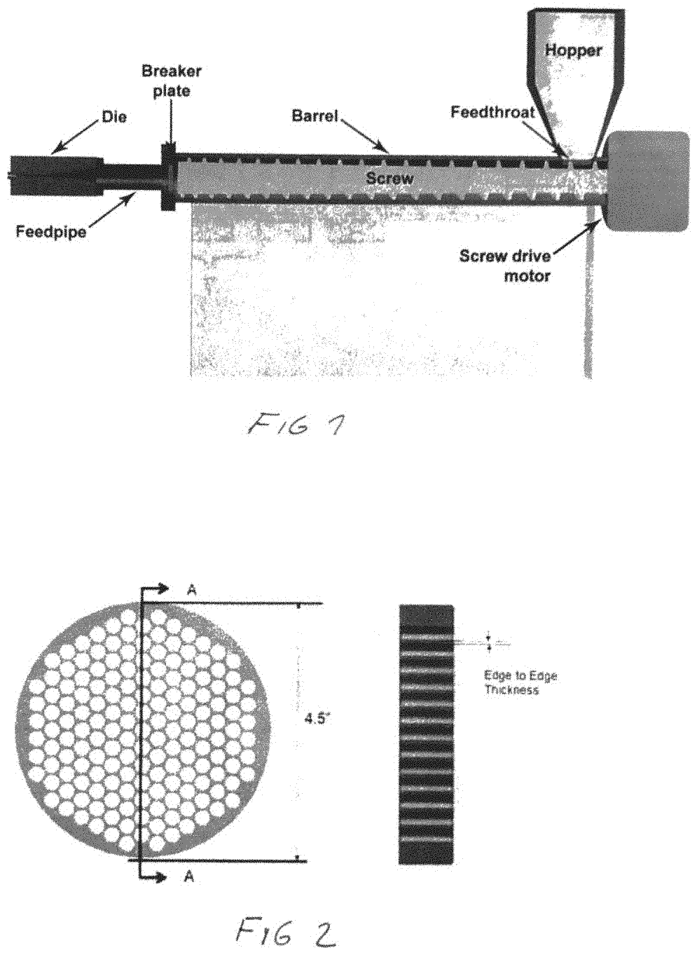

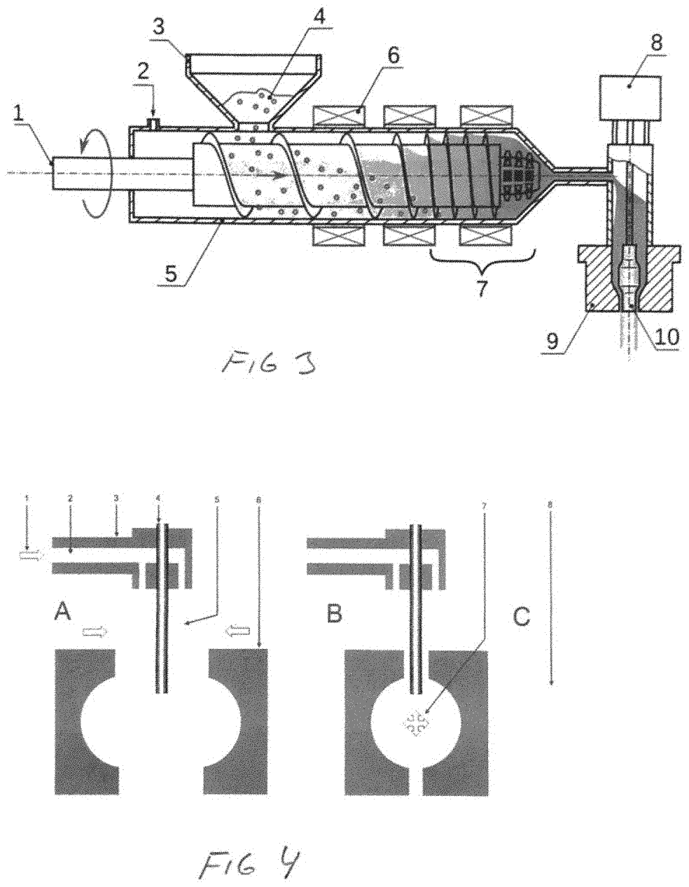

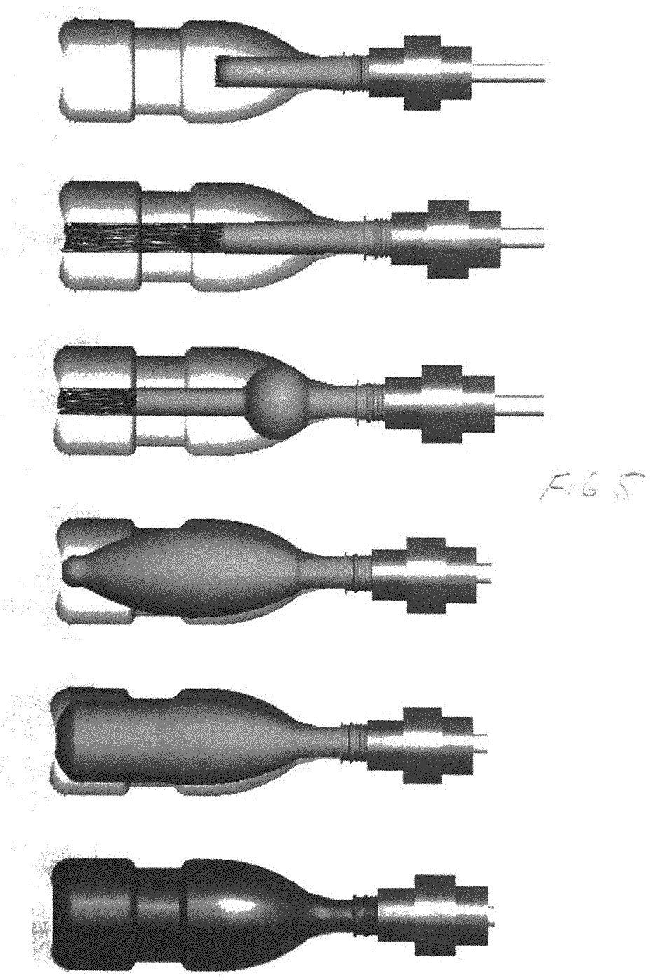

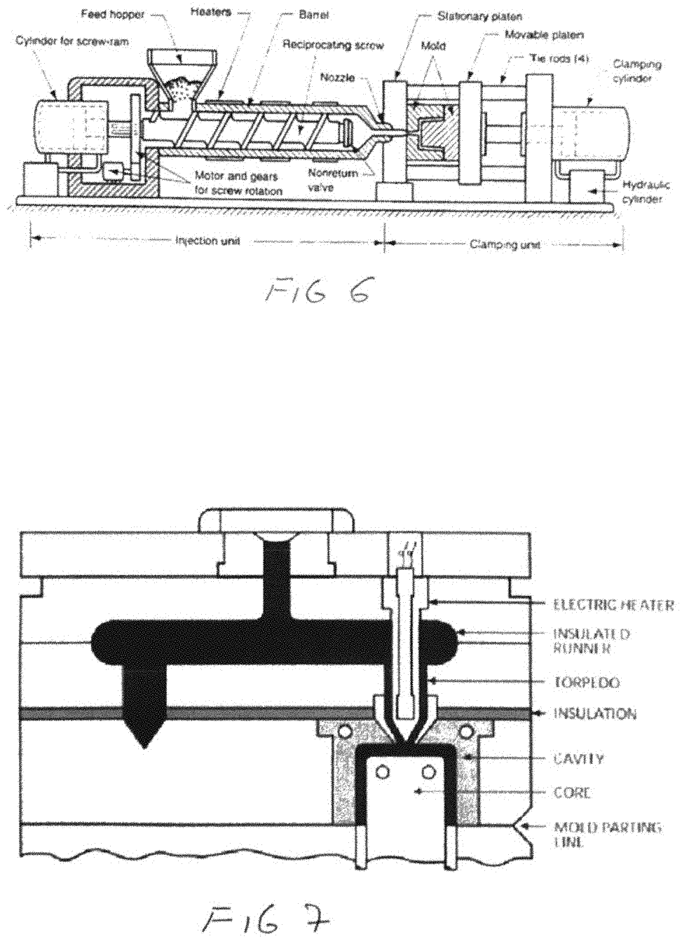

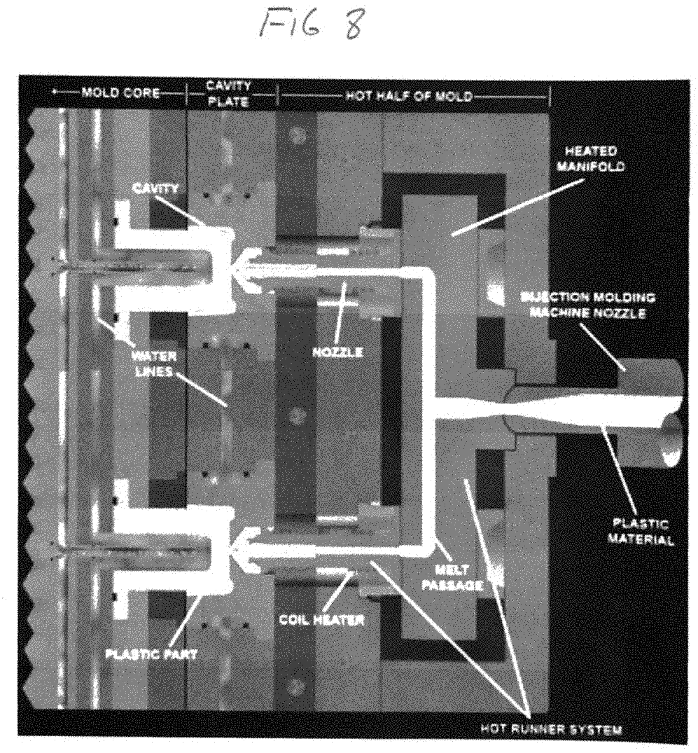

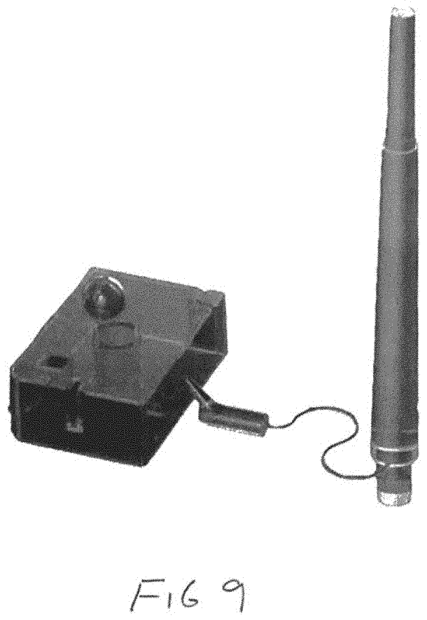

### DETAILED DESCRIPTION

All pressures disclosed herein are gauge pressures, which are pressures relative to ambient pressure.

Disclosed herein is a method of injection molding at low, substantially constant melt pressures. Embodiments of the disclosed method now make possible a method of injection molding that is more energy—and cost—effective than conventional high-velocity injection molding process. Embodiment of the disclosed method surprisingly allow for the filling of a mold cavity at low melt pressure without undesirable premature hardening of the thermoplastic material in the mold cavity and without the need for maintaining a constant temperature or heated mold cavity. As described in detail below, one of ordinary skill in the art would not have expected that a constant pressure method could be performed at low pressure without such premature hardening of the thermoplastic material when using an unheated mold cavity or cooled mold cavity.

Embodiments of the disclosed method also allow for the formation of quality injection molded parts that do not experience undesirable sink or warp without the need to balance the pre-injection mold cavity pressure and the pre-injection pressure of the thermoplastic materials. Thus, embodiments of the disclosed method can be performed using atmospheric mold cavities pressures and eliminate the need for including pressurizing means in the mold cavity.

Embodiments of the method can also produce quality injection molded parts with significantly less sensitivity to variations in the temperature, viscosity, and other such properties of the thermoplastic material, as compared to conventional high-pressure injection molding process. In one embodiment, this can advantageously allow for use of thermoplastic materials formed from recycled plastics (e.g., post-consumer recycled plastics), which inherently have batch-to-batch variation of the material properties.

Additionally, the low melt pressures used in the disclosed method can allow for use of low hardness, high thermal conductive mold cavity materials that are more cost effective to manufacture and are more energy efficient. For example, the mold cavity can be formed of a material having a surface hardness of less than 30 Rockwell C (Rc) and a thermal conductivity of greater than 30 BTU/HR FT ° F. In one embodiment, the mold cavity can be formed of an aluminum alloys, such as, for example aluminum alloys 6061 Al and 7075 Al.

Embodiments of the disclosed method can further allow for the formation of high quality thin-walled parts. For example, a molded part having a length of molten thermoplastic flow to thickness (L/T) ratio of greater than 100 can be formed using embodiments of the method. It is contemplated the embodiments of the method can also form molded parts having an L/T ratio greater than 200, and in some cases greater than 250.

Molded parts are generally considered to be thin walled when a length of a flow channel L divided by a thickness of the flow channel T is greater than 100 (i.e., L/T>100).

A sensor may be located near the end of fill in the mold. This sensor may provide an indication of when the melt front is approaching the end of fill in the mold. The sensor may sense pressure, temperature, optically, or other means of identifying the presence of the polymer. When pressure is measured by the sensor, this measure can be used to communicate with the central control unit to provide a target “packing pressure” for the molded component. The signal generated by the sensor can be used to control the molding process, such that variations in material viscosity, mold temperatures, melt temperatures, and other variations influencing filling rate, can be adjusted for by the central control unit. These adjustments can be made immediately during the molding cycle, or corrections can be made in subsequent cycles. Furthermore, several readings can be averaged over a number of cycles then used to make adjustments to the molding process by the central control unit. In this way, the current injection cycle can be corrected based on measurements occurring during one or more cycles at an earlier point in time. In one embodiment, sensor readings can be averaged over many cycles so as to achieve process consistency.

Once the mold is completely filled, the melt pressure and the mold pressure, if necessary, are reduced to atmospheric pressure at time and the mold cavity can be opened. During this time if using an injection molding machine, the reciprocating screw stops traveling forward. Advantageously, the low, substantially constant pressure conditions allow the shot comprising molten thermoplastic material to cool rapidly inside the mold, which, in various embodiments, can occur substantially simultaneously with venting of the melt pressure and the mold cavity to atmospheric pressure. Thus, the injection molded part can be ejected from the mold quickly after filling of the mold cavity with the shot comprising molten thermoplastic material.

Melt Pressure

As used herein, the term “melt pressure” refers to a pressure of the molten thermoplastic material as it is introduced into and fills a mold cavity of a molding apparatus. During filling of substantially the entire mold cavity, the melt pressure of the shot comprising molten thermoplastic material is maintained substantially constant at less than 6000 psi. The melt pressure of the shot comprising molten thermoplastic material during filling of substantially the entire mold cavity is significantly less than the injection and filling melt pressures used in conventional injection molding processes and recommended by manufacturers of thermoplastic materials for use in injection molding process. Other suitable melt pressures include, for example, less than 5000 psi, less than 4500 psi, less than 4000 psi, and less than 3000 psi. For example, the melt pressure can be maintained at a substantially constant pressure within the range of about 1000 psi to less than 6000 psi, about 1500 psi to about 5500 psi, about 2000 psi to about 5000 psi, about 2500 psi to about 4500 psi, about 3000 psi to about 4000 psi, and about 3000 psi to less than 6000 psi.

As described above, a “substantially constant pressure” refers to a pressure that does not fluctuate upwardly or downwardly from the desired melt pressure more than 30% of the desired melt pressure during filling of substantially the entire mold cavity with the shot comprising molten thermoplastic material. For example, the substantially constant pressure can fluctuate (either as an increase or decrease) from the melt pressure about 0% to about 30%, about 2% to about 25%, about 4% to about 20%, about 6% to about 15%, and about 8% to about 10%. Other suitable fluctuation amounts include about 0, 2, 4, 6, 8, 10, 12, 14, 16, 18, 20, 22, 24, 26, 28, and 30%. The melt pressure during filling of substantially the entire mold cavity can increase or decrease, respectively, for example, at a constant rate, and be considered substantially constant so long as the maximum increase or decrease in the melt pressure during filling of substantially the entire mold cavity is no greater than the 30% of the desired melt pressure. In yet another embodiment, the melt pressure during filling of substantially the entire mold cavity can increase over a portion of time and then decrease over a remaining portion of time. This fluctuation will be considered a substantially constant pressure so long as the maximum increase or decrease in the melt pressure during filing is less than 30% of the desired melt pressure.

The melt pressure of the thermoplastic material filling into the mold cavity can be measured using, for example, a pressure transducer disposed at the filling point. The location in the molding apparatus where the molten thermoplastic material enters the mold cavity. For example, for a molding apparatus having a single mold cavity coupled to a nozzle, the filling point can be at or adjacent to the nozzle. Alternatively, for a molding apparatus having a plurality of mold cavities and a runner system for transporting the molten thermoplastic material from the nozzle to each of the mold cavities, the filling points can be the points of contact between the runner system and each of the individual mold cavities. The molten thermoplastic material is maintained at the substantially constant melt pressure as it is transported through the runner system. In general, the runner system is a heated runner system that maintains the melt temperature of the shot comprising molten thermoplastic material as it is transported to the mold cavities.

The melt pressure of the thermoplastic material during filling of substantially the entire mold cavity can be maintained, for example, by measuring the melt pressure using a pressure transducer disposed at the nozzle and maintaining a constant pressure at the nozzle. In another embodiment, the melt pressure of the shot comprising thermoplastic material during filing of substantially the entire mold cavity can be measured using a pressure transducer disposed in the mold cavity opposite the gate.

In another embodiment, once substantially the entire mold cavity is filled, the melt pressure can be increased to fill and pack the remaining portion of the mold cavity.

Maintaining Substantially Constant Pressure

A closed loop controller and/or another pressure regulating devices may be used instead of the closed loop controller. For example, a pressure regulating valve (not shown) or a pressure relief valve (not shown) may replace a controller to regulate the melt pressure of the molten thermoplastic material. More specifically, the pressure regulating valve and pressure relief valve can prevent over pressurization of the mold. Another alternative mechanism for preventing over pressurization of the mold is to activate an alarm when an over pressurization condition is detected.

Thus in another embodiment, the molding apparatus can include a pressure relief valve disposed between an breaker plate and the mold cavity. The pressure relief valve has a predetermined pressure set point, which is equal to desired melt pressure for the filling of the mold. The melt pressure during the filling of the mold cavity is maintained substantially constant by applying a pressure to the molten thermoplastic material to force the molten thermoplastic material through the pressure relief valve at a melt pressure higher than the predetermined set point. The pressure relief valve then reduces the melt pressure of the thermoplastic material as it passes through the pressure relief valve and is introduced into the mold cavity. The reduced melt pressure of the molten thermoplastic material corresponds to the desired melt pressure for filling of the mold cavity and is maintained substantially constant by the predetermined set point of the pressure release valve.

In one embodiment, the melt pressure is reduced by diverting a portion of thermoplastic material to an outlet of the pressure relief valve. The diverted portion of the thermoplastic material can be maintained in a molten state and can be reincorporated into the injection system, for example, through the heated barrel.

Mold Cavity Pressure

As used herein, the “mold cavity pressure” refers to the pressure within a closed mold cavity and/or an open extrusion mold, and/or blow molding mold. The mold cavity and/or an open extrusion mold, and/or blow molding mold. Pressure can be measured, for example, using a pressure transducer placed inside the mold cavity and/or an open extrusion mold, and/or blow molding mold. In embodiments of the method, prior to introducing molten thermoplastic material into the mold cavity and/or an open extrusion mold, and/or blow molding mold., the mold cavity pressure is different than the pressure of the molten thermoplastic material. For example, the mold cavity pressure can be less than the pressure of the molten thermoplastic material. In another embodiment, the mold cavity pressure can be greater than the pressure of the molten thermoplastic material. The mold cavity pressure can have a pressure greater than atmospheric pressure. In yet another embodiment, the mold cavity can be maintained at a vacuum prior to and/or during filling.

In various embodiments, the mold cavity and/or breaker plate pressure can be maintained substantially constant during filling of substantially the entire mold cavity with the shot comprising molten thermoplastic material. The term “substantially constant pressure” as used herein with respect to a melt pressure of a thermoplastic material, means that deviations from a baseline melt pressure do not produce meaningful changes in physical properties of the thermoplastic material. For example, “substantially constant pressure” includes, but is not limited to, pressure variations for which viscosity of the melted thermoplastic material do not meaningfully change. The term “substantially constant” in this respect includes deviations of up to approximately 30% from a baseline melt pressure. For example, the term “a substantially constant pressure of approximately 4600 psi” includes pressure fluctuations within the range of about 6000 psi (30% above 4600 psi) to about 3200 psi (30% below 4600 psi). A melt pressure is considered substantially constant as long as the melt pressure fluctuates no more than 30% from the recited pressure.

For example, the substantially constant pressure can fluctuate (either as an increase or decrease) from the melt pressure about 0% to about 30%, about 2% to about 25%, about 4% to about 20%, about 6% to about 15%, and about 8% to about 10%. Other suitable fluctuation amounts include about 0, 2, 4, 6, 8, 10, 12, 14, 16, 18, 20, 22, 24, 26, 28, and 30%. The mold cavity pressure can be maintained substantially constant at a pressure greater than atmospheric pressure.

The mold cavity can include, for example, one or more vents for maintaining the mold cavity pressure substantially constant. The vents can be controlled to open and close in order to maintain the substantially constant mold cavity pressure.

In one embodiment, a vacuum can be maintained in the filling of substantially the entire mold cavity with the molten thermoplastic. Maintaining a vacuum in the mold cavity during injection can advantageously reduce the amount of melt pressure required to fill the cavity, as there is no air to force from the mold cavity during filling. The lack of air resistance to the flow and the increased pressure drop between the melt pressure and the end of fill pressure can also result in a greater flow length of the shot comprising molten thermoplastic material.

Mold Temperature

In embodiments of the method, the mold cavity is maintained at room temperature or cooled prior to filling of the mold with the molten thermoplastic material. While the mold surfaces may increase in temperature upon contact with the molten thermoplastic material, an internal portion of the mold cavity spaced at least 2 mm, at least 3 mm, at least 4 mm, at least 5 mm, at least 6 mm, at least 7 mm, at least 8 mm, at least 9 mm, or at least 10 mm from the most immediate surface of the mold cavity contacting the thermoplastic material is maintained at a lower temperature. Typically, this temperature is less than the no-flow temperature of the thermoplastic material. As used herein, the “no-flow temperature” refers to the temperature at which the viscosity of the thermoplastic material is so high that it effectively cannot be made to flow. In various embodiments, the internal portion of the mold can be maintained at a temperature of less than 100° C. For example, the internal portion can be maintained at a temperature of about 10° C. to about 99° C., about 20° C. to about 80° C., about 30° C. to about 70° C., about 40° C. to about 60° C., and about 20° C. to about 50° C. Other suitable temperatures include, about 10, 15, 20, 25, 30, 35, 40, 45, 50, 55, 60, 65, 70, 75, 80, 85, 90, 95, or 99° C. In one embodiment, the internal portion is maintained at a temperature of less than 50° C.

Heretofore, when filling at low constant pressure, the filling rates were reduced relative to conventional filling methods. This means the polymer would be in contact with the cool molding surfaces for longer periods before the mold would completely fill. Thus, more heat would need to be removed before filling, and this would be expected to result in the material freezing off before the mold is filled. It has been unexpectedly discovered that the thermoplastic material will flow when subjected to low, substantially constant pressure conditions despite a portion of the mold cavity being below the no-flow temperature of the thermoplastic material. It would be generally expected by one of ordinary skill in the art that such conditions would cause the thermoplastic material to freeze and plug the mold cavity rather than continue to flow and fill the entire mold cavity. Without intending to be bound by theory, it is believed that the low, substantially constant pressure conditions of embodiments of the disclosed method allow for dynamic flow conditions (i.e., constantly moving melt front) throughout the entire mold cavity during filling. There is no hesitation in the flow of the molten thermoplastic material as it flows to fill the mold cavity and, thus, no opportunity for freeze-off of the flow despite at least a portion of the mold cavity being below the no-flow temperature of the thermoplastic material. Additionally, it is believed that as a result of the dynamic flow conditions, the molten thermoplastic material is able to maintain a temperature higher than the no-flow temperature, despite being subjected to such temperatures in the mold cavity, as a result of shear heating. It is further believed that the dynamic flow conditions interfere with the formation of crystal structures in the thermoplastic material as it begins the freezing process. Crystal structure formation increases the viscosity of the thermoplastic material, which can prevent suitable flow to fill the cavity. The reduction in crystal structure formation and/or crystal structure size can allow for a decrease in the thermoplastic material viscosity as it flows into the cavity and is subjected to the low temperature of the mold that is below the no-flow temperature of the material.

In various embodiments, the mold can include a cooling system that maintains the entire mold cavity at a temperature below the no-flow temperature. For example, even surfaces of the mold cavity which contact the molten thermoplastic material can be cooled to maintain a lower temperature. Any suitable cooling temperature can be used. For example, the mold can be maintained substantially at room temperature. Incorporation of such cooling systems can advantageously enhance the rate at which the as-formed plastic part leaves the mold.

Thermoplastic Material

A variety of thermoplastic materials can be used in the low, substantially constant pressure injection molding methods of the disclosure. In one embodiment, the molten thermoplastic material has a viscosity, as defined by the melt flow index of about 0.1 g/10 min to about 500 g/10 min, as measured by ASTM D1238 performed at a temperature of about 230 C and a weight of 2.16 kg. For example, for polypropylene the melt flow index can be in a range of about 0.5 g/10 min to about 200 g/10 min. Other suitable melt flow indexes include about 1 g/10 min to about 400 g/10 min, about 10 g/10 min to about 300 g/10 min, about 20 to about 200 g/10 min, about 30 g/10 min to about 100 g/10 min, about 50 g/10 min to about 75 g/10 min, about 0.1 g/10 min to about 1 g/10 min, or about 1 g/10 min to about 25 g/10 min. The MFI of the material is selected based on the application and use of the molded article. For examples, thermoplastic materials with an MFI of 0.1 g/10 min to about 5 g/10 min may be suitable for use as preforms for Injection Stretch Blow Molding (ISBM) applications. Thermoplastic materials with an MFI of 5 g/10 min to about 50 g/10 min may be suitable for use as caps and closures for packaging articles. Thermoplastic materials with an MFI of 50 g/10 min to about 150 g/10 min may be suitable for use in the manufacture of buckets or tubs. Thermoplastic materials with an MFI of 150 g/10 min to about 500 g/10 min may be suitable for molded articles that have extremely high L/T ratios such as a thin plate. Manufacturers of such thermoplastic materials generally teach that the materials should be injection molded using melt pressures in excess of 6000 psi, and often in great excess of 6000 psi. Contrary to conventional teachings regarding injection molding of such thermoplastic materials, embodiments of the low, constant injection molding method of the disclosure advantageously allow for forming quality injection molded parts using such thermoplastic materials and processing at melt pressures below 6000 psi, and possibly well below 6000 psi.

The thermoplastic material can be, for example, a polyolefin. Exemplary polyolefins include, but are not limited to, polypropylene, polyethylene, polymethylpentene, and polybutene-1. Any of the aforementioned polyolefins could be sourced from bio-based feedstocks, such as sugarcane or other agricultural products, to produce a bio-polypropylene or bio-polyethylene. Polyolefins advantageously demonstrate shear thinning when in a molten state. Shear thinning is a reduction in viscosity when the fluid is placed under compressive stress. Shear thinning can beneficially allow for the flow of the thermoplastic material to be maintained throughout the injection molding process. Without intending to be bound by theory, it is believed that the shear thinning properties of a thermoplastic material, and in particular polyolefins, results in less variation of the materials viscosity when the material is processed at low pressures. As a result, embodiments of the method of the disclosure can be less sensitive to variations in the thermoplastic material, for example, resulting from colorants and other additives as well as processing conditions. This decreased sensitivity to batch-to-batch variations of the properties thermoplastic material can also advantageously allow post-industrial and post-consumer recycled plastics to be processed using embodiments of the method of the disclosure. Postindustrial and post-consumer recycled plastics are derived from end products that have completed their life cycle and would otherwise have been disposed of as a solid waste product. Such recycled plastic, and blends of thermoplastic materials, inherently have significant batch-to-batch variation of their material properties.

The thermoplastic material can also be, for example, a polyester. Exemplary polyesters include, but are not limited to, polyethylene terphthalate (PET). The PET polymer could be sourced from bio-based feedstocks, such as sugarcane or other agricultural products, to produce a partially or fully bio-PET polymer. Other suitable thermoplastic materials include copolymers of polypropylene and polyethylene, and polymers and copolymers of thermoplastic elastomers, polyester, polystyrene, polycarbonate, poly(acrylonitrile-butadiene-styrene), poly(lactic acid), bio-based polyesters such as poly(ethylene furanate) polyhydroxyalkanoate, poly(ethylene furanoate), (considered to be an alternative to, or drop-in replacement for, PET), polyhydroxyalkanoate, polyamides, polyacetals, ethylene-alpha olefin rubbers, and styrene-butadiene-styrene block copolymers. The thermoplastic material can also be a blend of multiple polymeric and non-polymeric materials. The thermoplastic material can be, for example, a blend of high, medium, and low molecular polymers yielding a multi-modal or bi-modal blend. The multi-modal material can be designed in a way that results in a thermoplastic material that has superior flow properties yet has satisfactory chemo/physical properties. The thermoplastic material can also be a blend of a polymer with one or more small molecule additives. The small molecule could be, for example, a siloxane or other lubricating molecule that, when added to the thermoplastic material, improves the flowability of the polymeric material.

Other additives may include foaming agents and other expanding additives, inorganic fillers such calcium carbonate, calcium sulfate, talcs, clays (e.g., nanoclays), aluminum hydroxide, CaSiO3, glass formed into fibers or microspheres, crystalline silicas (e.g., quartz, novacite, crystallobite), magnesium hydroxide, mica, sodium sulfate, lithopone, magnesium carbonate, iron oxide; or, organic fillers such as rice husks, straw, hemp fiber, wood flour, or wood, bamboo or sugarcane fiber.

Other suitable thermoplastic materials include renewable polymers such as nonlimiting examples of polymers produced directly from organisms, such as polyhydroxyalkanoates (e.g., poly(beta-hydroxyalkanoate), poly(3-hydroxybutyrate-co-3-hydroxyvalerate, NODAX (Registered Trademark)), and bacterial cellulose; polymers extracted from plants, agricultural and forest, and biomass, such as polysaccharides and derivatives thereof (e.g., gums, cellulose, cellulose esters, chitin, chitosan, starch, chemically modified starch, particles of cellulose acetate), proteins (e.g., zein, whey, gluten, collagen), lipids, lignins, and natural rubber; thermoplastic starch produced from starch or chemically starch and current polymers derived from naturally sourced monomers and derivatives, such as bio-polyethylene, bio-polypropylene, polytrimethylene terephthalate, polylactic acid, NYLON 11, alkyd resins, succinic acid-based polyesters, and bio-polyethylene terephthalate.

The suitable thermoplastic materials may include a blend or blends of different thermoplastic materials such in the examples cited above. As well the different materials may be a combination of materials derived from virgin bio-derived or petroleum-derived materials, or recycled materials of bio-derived or petroleum-derived materials. One or more of the thermoplastic materials in a blend may be biodegradable. And for non-blend thermoplastic materials that material may be biodegradable.

Exemplary thermoplastic resins together with their recommended operating pressure ranges are provided in the following chart:

Injection Pressure Material Material Full Name Range (PSI) Company Brand Name pp Polypropylene 10000-15000 RTP RTP

100 Imagineering series Plastics Poly—propylene Nylon 10000-18000 RTP RTP

200 Imagineering series Plastics Nylon ABS Acrylonitrile 8000-20000 Marplex Astalac Butadiene ABS Styrene PET Polyester 5800-14500 Asia AIE PET International 401F Acetal 7000-17000 API

Kolon Kocetal Copolymer PC Polycarbonate 10000-15000 RTP RTP

300 Imagineering series Plastics Poly—carbonate PS Polystyrene 10000-15000 RTP RTP 400 Imagineering series Plastics SAN Styrene 10000-15000 RTP RTP 500 Acrylonitrile Imagineering series Plastics PE LDPE & 10000-15000 RTP RTP 700 HDPE Imagineering Series Plastics TPE Thermoplastic 10000-15000 RTP RTP 1500 Elastomer Imagineering series Plastics PVDF Polyvinylidene 10000-15000 RTP RTP 3300 Fluoride Imagineering series Plastics PTI Poly—10000-15000 RTP RTP

4700 trimethylene Imagineering series Terephthalate Plastics PBT Polybutylene 10000-15000 RTP RTP 1000 Terephthalate Imagineering series Plastics PLA Polylactic Acid 8000-15000 RTP RTP 2099 Imagineering series Plastics

While the molten thermoplastic material maintaining the melt pressure of the molten thermoplastic material at a substantially constant pressure of less than 6000 psi, specific thermoplastic materials benefit from the invention at different constant pressures. Specifically: PP, nylon, PC, PS, SAN, PE, TPE, PVDF, PTI, PBT, and PLA at a substantially constant pressure of less than 10000 psi; ABS at a substantially constant pressure of less than 8000 psi; PET at a substantially constant pressure of less than 5800 psi; Acetal copolymer at a substantially constant pressure of less than 7000 psi; plus poly(ethylene furanate) polyhydroxyalkanoate, polyethylene furanoate (aka PEF) at substantially constant pressure of less than 10000 psi, or 8000 psi, or 7000 psi or 6000 psi, or 5800 psi.

As described above, a low and substantially constant pressure method can achieve one or more advantages over conventional molding processes e.g. being cost effective and having a efficient process that eliminates the need to balance the pre-injection pressures of the mold cavity and the thermoplastic materials, a process that allows for use of atmospheric mold cavity pressures and, thus, simplified mold structures that eliminate the necessity of pressurizing means, the ability to use lower hardness, high thermal conductivity mold cavity materials that are more cost effective and easier to machine, a more robust processing method that is less sensitive to variations in the temperature, viscosity, and other material properties of the thermoplastic material, and the ability to produce quality injection molded parts at low pressures without premature hardening of the thermoplastic material in the mold cavity and without the need to heat or maintain constant temperatures in the mold cavity.

Parts molded using a conventional, higher pressure process usually have a reduced number of oriented bands when compared to a part molded using a low constant pressure process.

Parts molded using a low constant pressure process may have less molded-in stress. In a conventional process, the velocity-controlled filling process combined with a higher transfer or switchover to pressure control may result in a part with high levels of undesirable molded-in stress. If the pack pressure is set too high in a conventional process, the part will often have an over-packed gate region.

Moreover, one skilled in the art will recognize the teachings disclosed herein may be used in the construction of stack molds, multiple material molds including rotational and core back molds, in combination with in-mold decoration, insert molding, in mold assembly, and the like.

While particular embodiments have been illustrated and/or described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

The method and/or machinery could also use constant low-pressure molding in an injection blow molding process, by controlling the filling process by actual plastic pressure filling and packing the mold and/or part of the mold using a low and constant plastic pressure, that eliminates flow hesitations, packs the part as it fills, and reduces pressure loss within the mold as it fills, the polymer is injection molded onto a core pin; then the core pin is rotated to a blow molding station to be inflated and cooled. The process is divided into three steps: injection, blowing and ejection.

The method and/or machinery could also use constant low-pressure molding in an extrusion blow molding process, by controlling the filling process by actual plastic pressure filling and packing the mold and/or part of the mold using a low and constant plastic pressure, that eliminates flow hesitations, packs the part as it fills, and reduces pressure loss within the mold as it fills, plastic is melted and extruded into a hollow tube (a parison). This parison is then captured by closing it into a cooled metal mold. Air is then blown into the parison, inflating it into the shape of the hollow bottle, container, or part. After the plastic has cooled sufficiently, the mold is opened, and the part is ejected. Continuous and Intermittent are two variations of Extrusion Blow Molding. In continuous extrusion blow molding the parison is extruded continuously and the individual parts are cut off by a suitable knife. In Intermittent blow molding there are two processes: straight intermittent is similar to injection molding whereby the screw turns, then stops and pushes the melt out. With the accumulator method, an accumulator gathers melted plastic and when the previous mold has cooled and enough plastic has accumulated, a rod pushes the melted plastic and forms the parison. In this case the screw may turn continuously or intermittently. With continuous extrusion the weight of the parison drags the parison and makes calibrating the wall thickness difficult. The accumulator head or reciprocating screw methods use hydraulic systems to push the parison out quickly reducing the effect of the weight and allowing precise control over the wall thickness by adjusting the die gap with a parison programming device.

The method and/or machinery could also use constant low-pressure molding in extruders for 3D printingTypes of extruders (depending on the drive) by controlling the process by actual plastic pressure leaving the nozzle, e.g. having an adjustable nozzle and/or breaker plate/pressure valve enabling the nozzle to distribute its material at a low and constant plastic pressure, that eliminates flow hesitations. Within extruders for 3D printing there are two types depending on the type of drive: Direct and Bowden. In the direct extruder, as its name suggests, the filament runs directly from the cog of the extruder to the HotEnd. There are even systems in which these two parts are together.

The method and/or machinery could also have a constant low-pressure extrusion in an injection molding machine given the constant low-pressure molding by controlling the filling process by actual plastic pressure filling and packing the mold and/or part of the mold using a low and constant plastic pressure, that eliminates flow hesitations, packs the part as it fills, and reduces pressure loss within the mold as it fills using at least one breaker plate to build the necessary back pressure needed to keep a constant low pressure. The holes in the breaker plate would automatic create some friction heat and having a heat sensor on both sides of the breaker plate would enable a better control and uniformity of the plastic material passing through the breaker plate e.g. also having the breaker plate temperature controlled by cooling and/or heating measures

The method and/or machinery could also have a constant low-pressure extrusion in an injection molding machine where the breaker plate and/or pressure valve could be added to the injection unit and/or being built in to a manifold being bolted on to the mold in the machine and/or being part of such mold e.g. built in to a hot runner manifold. The apparatus holding the breaker plate and/or pressure valve could also be controlling shear heat and/or measuring the temperature of the material entering and/or leaving the obstacle/pass way creating the shear heat e.g. the breaker plate potentially having the possibility to control the passage size creating the shear heat. This could include the control of heat, cooling, pressure and flow speed to achieve the desired output

The method and/or machinery could also have a breaker plate in the injection unit of an injection molding machine given the constant low-pressure molding using at least one breaker plate to control the uniformity of the material composition including temperature. A breaker plate could also be placed in the hot runner manifold of the mold in the injection molding machine. Here having the benefit that the hot runner system already was set up for temperature control. And now it would also be possible to control friction heat e.g. if the holes in the breaker plate was matching the size of the gates into the cavity/cavities.

The method and/or machinery could also have a constant extrusion with at least on breaker plate having traps build in enabling separation of materials of different density, viscosity e.g. also with temperature deviations like having hot and cooler areas for the material to pass this made possible given the constant low pressure. Consistent low pressure protects the plastic material from degenerating and makes it much better to recycle both coming from virgin material as well as going through the recycling process. When different types of plastics are melted together, they tend to phase-separate, like oil and water, and set in these layers. The phase boundaries cause structural weakness and delamination in the resulting material, meaning that polymer blends are useful in only limited applications. The two most widely manufactured plastics, polypropylene and polyethylene, behave this way, which limits their utility for recycling. Each time plastic is recycled, additional virgin materials must be added to help improve the integrity of the material. So, even recycled plastic has almost always new plastic material added in. The same piece of plastic can only be recycled about 2-3 times before its quality decreases to the point where it can no longer be used. Consistent low pressure protect the plastic material from degenerating and makes it much better to recycle and when processed through an extruder under consistent low pressure it could e.g. be possible to direct dissimilar materials in a fixed direction enabling separation and/or centering of the unwanted and/or wanted material into the center core of a given extruded profile minimizing surface blemishes and delamination of the extruded product.

The method and/or machinery could also have a constant extrusion with at least on breaker plate having traps build in enabling enhanced mixing/compounding of materials of different density, viscosity e.g. also with temperature deviations like having hot and cooler areas for the material to flow through positioning e.g. additives like glass fiber or blowing agent in the center of the melt flow enabling enhanced surface on the finished parts, this made possible given the constant low pressure. Consistent low pressure also enabling a longer profile in the extrusion mold with extra cooling due to the no hesitation in the flow front enabling straighter and more homogenic extruded profiles leaving the extruder.

The method and/or machinery could also have a constant extrusion with at least on breaker plate having traps build in enabling separation of materials of different density, viscosity e.g. in a twin extruder e.g. with dissimilar screws e.g. also with temperature deviations like having hot and cooler areas/zones in the extruder for the material to pas through. This made possible given the constant low pressure that has proven an excellent success rate going thick to thin and back to thick without hesitation in uneven fill rates in cavities in injection molds. Consistent low pressure furthermore protects the plastic material from degenerating and makes it much better to recycle both coming from virgin material as well as going through the recycling process.

The method and/or machinery could also have a constant extrusion in an injection molding machine given the constant low pressure molding allowing a traditional injection unit to have much larger and more humogen plasticizing output extruding the plastic into the cavity/cavities than just injecting the plasticized material is in front of the screw tip, also needing a material cushion left in front of the screw for injection into the mold during the holding pressure phase.

The method and/or machinery could also have a constant extrusion in an injection molding machine given the constant low pressure molding using at least one breaker plate to build the necessary back pressure needed to keep a constant low pressure when using the extrusion feature on a injection unit on a traditional injection molding machine. This would also enable a given injection molding machine to have a much wider range of shot weight without the degeneration of the material in the injection unit.

The method and/or machinery could also have a constant extrusion in an injection molding machine given the constant low pressure molding using at least one breaker plate to build the necessary back pressure needed to keep a constant low pressure when using the extrusion feature on an injection unit on a traditional injection molding machine. E.g. combining the extrusion feature with injecting the plasticized material is in front of the screw tip thereby increasing the material that can be introduced into the cavity/cavities in the machine and e.g. applying a constant extrusion of the material using the space in front of the screw to hold a cushion while the mold open and closes and/or during the holding pressure phase of the molding process. These features could also be used in one of the three main types of blow molding: extrusion blow molding, injection blow molding, and injection stretch blow molding.

The method and/or machinery could also have a blow mold that has a cavity that fills (e.g. neck and thread on a bottle) due to the low constant fill without hesitation where the material packs as it fills where after filling neck and thread turns into extrusion e.g. by mechanically opening space for the extrusion, and/or injection of a parison by controlling the filling process during the actual plastic pressure filling and packing the mold and/or part of the mold using a low and constant plastic pressure, that eliminates flow hesitations, packs the part as it fills, and reduces pressure loss within the mold as it fills. The parison is then clamped into a mold and air is blown into it. The air pressure then pushes the plastic out to match the mold. Once the plastic has cooled and hardened the mold opens up and the part is ejected.

The method and/or machinery could also have a constant extrusion in an blow molding machine given the constant low pressure molding using at least one breaker plate and/or pressure valve to build the necessary back pressure needed to keep a constant low pressure enabling it to pack e.g. the entry area (the neck and thread portion) of a bottle blow mold as it fills, where after it acts as an extrusion mold for the rest of the parison. The parison is then clamped into a mold and air is blown into it. The air pressure then pushes the plastic out to match the mold. Once the plastic has cooled and hardened the mold opens up and the part is ejected.

The method and/or machinery could also have a constant extrusion in an blow molding machine given the constant low pressure molding using at least one breaker plate and/or pressure valve to build the necessary back pressure needed to keep a constant low pressure enabling it to pack e.g. the entry area (the neck and thread portion) of a bottle blow mold as it fills this packable portion of the blow mold e.g. having slides and/or core pulls being movable in respect to the rest of the blow mold.

The method and/or machinery could also have a constant low pressure extrusion in an blow molding machine given the constant low pressure molding using at least one breaker plate and/or pressure valve to build the necessary back pressure needed to keep a constant low pressure enabling and/or controlling the filling process by actual plastic pressure filling and packing the mold and/or part of the mold using a low and constant plastic pressure, that eliminates flow hesitations, packs the part as it fills, and reduces pressure loss within the mold as it fills it to pack material in part and/or in full using one of the three main types of blow molding: extrusion blow molding, injection blow molding, and injection stretch blow molding.

The method and/or machinery could also have a constant extrusion in an blow molding machine given the constant low pressure molding using at least one breaker plate and/or pressure valve to build the necessary back pressure needed to keep a constant low pressure enabling it to pack the material better and more consistent in parison and/or preform enabling a better blow molded product.

The method and/or machinery could also have a constant low pressure extrusion in an blow molding machine given the constant low pressure molding using at least one breaker plate to build the necessary back pressure needed to keep a constant low pressure enabling it to pack e.g. the entry area (the neck and thread portion) of a bottle blow mold as it fills.

The method and/or machinery controlling the filling process by actual plastic pressure filling and packing the extrusion mold and/or part of the mold using a low and constant plastic pressure, that eliminates flow hesitations, packs the part as it fills, and reduces pressure loss within the mold as it fills could also have a compression molding feature compressing the initial plastic profile as it comes out the extrusion tool from one or more angles/surfaces

The method and/or machinery could also have a compression molding feature having one or more compressing wheels with continues compressing cavities and/or cores shaping the initial plastic profile as it comes out the extrusion tool from one or more angles/surfaces

The method and/or machinery could also have a continues low pressure label applied to the plastic profile as it comes out the extrusion tool from one or more angles/surfaces

The method and/or machinery could also have a continues low barrier label applied to the plastic profile as it comes out the extrusion tool from one or more angles/surfaces

The method and/or machinery could also have a continues stamping/cutting and/or shaping of parts from the plastic profile as it comes out the extrusion tool from one or more angles/surfaces

The method and/or machinery could also have a continues stamping/cutting and/or shaping of parts from the plastic profile as it comes out the extrusion tool having the excess material from the plastic profile returned into the extruder for a continues re-use

The method and/or machinery could also have a continues stamping/cutting and/or shaping of pre-foamed preforms for e.g. shoe soles from the plastic profile as it comes out the extrusion tool from one or more angles/surfaces followed by the preform getting placed in a heated mold cavity for the final expansion and/or compression

The method and/or machinery could also have a continues stamping/cutting and/or shaping of parts from the plastic profile as it comes out the extrusion tool from one or more angles/surfaces where one of the operations is pressing a hinge function into the profile and bending the hinge stretching the plastic molecules into the opening direction enhancing the function and lifetime of the hinge

The method and/or machinery could also have a new innovative hot runner system due to the possibilities of the constant low-pressure technology controlling the filling process by actual plastic pressure filling and packing the mold and/or part of the mold using a low and constant plastic pressure, that eliminates flow hesitations, packs the part as it fills, and reduces pressure loss within the mold as it fills. Having proved that it enables filling of unbalanced and/or different size cavities. Therefore, the manifolds of this new hot runner system would need less height since it would not need the extra layers to balance the different hot runner drops. The new system could e.g. have small breaker plates of e.g. different configuration to e.g. accommodate a straight feed line to e.g. ten hot runner drops.

The method and/or machinery could also have a new innovative hot runner system due to the constant low-pressure technology that has proved that it enables filling of unbalanced and/or different size cavities. Therefore, the manifolds of this new hot runner system would need less height and could have more cavities feed by hot runner drops in a given mold plate due to the design freedom in having the need for a balanced feed system as current hot runner systems have for injection molding today.

The method and/or machinery could also have a new innovative hot runner system due to the constant low-pressure technology that has proved that it enables filling of unbalanced and/or different size cavities. Therefore, the manifolds of this new hot runner system could enable extrusion molding and the different forms of blow molding to benefit from these new hot runner systems that in standard injection molds with cold runners have shown how long thin cold runner lines can feed thick walled parts in cavities without any and/or very little hesitation in the fill pattern.

The method and/or machinery could also have a new innovative hot runner system based on the possibilities of the constant low-pressure technology enabling e.g. a 0.030 inch. Diameter runner Having a 3-inch long “filament” portion before entering and filling the cavity of the part without freezing diameter and length can vary depending on part size and choice of material. Having at least one cold runner portion that is reheated during every molding cycle before injection of the next portion molten plastic material making the thin filament molten again and given a relative thin diameter of the filament it can be reheated relative fast eliminating the use of expensive standard hot runner drops.

The method and/or machinery could also have a new innovative hot runner system based on the possibilities of the constant low-pressure technology enabling e.g. a 0.030 inch. Diameter runner Having a 3-inch long “filament” portion before entering and filling the cavity of the part without freezing diameter and length can vary depending on part size and choice of material. Having at least one cold runner portion that is reheated during every molding cycle before injection of the next portion molten plastic material making the thin filament molten again and given a relative thin diameter of the filament it can be reheated relative fast

For heating non-conductive materials such as plastics, induction can be used to heat an electrically conductive susceptor e.g., graphite, which then passes the heat to the non-conducting material. Induction produces an electromagnetic field in a coil to transfer energy to a work piece to be heated. The material used to make the work piece can be a metal such as copper, aluminum, steel, brass or aloeids and mixed materials created for strength and conductivity. It can also be a semiconductor such as graphite, carbon or silicon carbide. Induction heating finds applications in processes where temperatures are as low as 100° C. (212° F.) and as high as 3000° C. (5432° F.).

Other heating applications can be used to reheat the filament parts of the mold and in it might also be possible to use this new innovative hot runner system for high pressure injection molding application. The filament part could also be a more traditional form of gate design that resides in a mold part/component that can be reheated a predetermined time during each injection molding cycle.

The method and/or machinery could also have a new innovative hot runner system having conductive heating as heating source in whole or in part e.g. in combination with a traditional heated hot runner manifold. The conductive heating as heating source in whole or in part could also be used in combination with a three plate molds that are used when part of the cold runner system is on a different plane to the injection location. The runner system for a three-plate mold sits on a second parting plane parallel to the main parting plane. This second parting plane enables the runners and sprue to be ejected when the mold is opened.

The conductive heating as heating source in whole or in part could also be used in combination with insulated runners that normally are unheated, this type of runner requires extremely thick runner channels to stay molten during continuous cycling. These molds have extra-large passages formed in the mold plate. During the fabrication process, the size of the passages in conjunction with the heat applied with each shot results in an open molten flow path. This inexpensive system eliminates the added cost of the manifold and drops but provides flexible gates of a heated hot runner system. It allows for easy color changes.

The abovementioned suggestions are meant to be used in both as standalone and in combinations and in part combinations not limited to any of the described molding technologies in creation of new patent claims for current and/or dependent patent applications.

1. A method comprising:
(a) filling a molten thermoplastic material into an at least one mold cavity of a molding apparatus, the molten thermoplastic material having a melt pressure that, upon entering into the at least one mold cavity, exceeds a pre-injection pressure of the molten thermoplastic material; and,
(b) while filling the at least one mold cavity with the molten thermoplastic material, maintaining the melt pressure substantially constant at less than 6000 psi,
wherein:
the thermoplastic material has a melt flow index of about 0.1 g/10 min to about 500 g/10 min.

2. The method of claim 1, wherein the molding apparatus comprises a breaker plate in the manifold having heated runners in fluid communication with the at least one mold cavity, wherein the melt pressure of the molten thermoplastic material is maintained substantially constant while the molten thermoplastic material is transported from an entry point through the breaker plate to the heated runners.

3. The method of claim 1, wherein the filling of the molten thermoplastic material into the at last one mold cavity comprises applying a hydraulic pressure to the molten thermoplastic material, and wherein maintaining the constant melt pressure comprises monitoring the melt pressure of the molten thermoplastic material upon entering into the at least one mold cavity and the melt pressure of the molten thermoplastic material during filling of the at least one mold cavity, and adjusting the hydraulic pressure applied to the molten thermoplastic material entering into the at least one mold cavity.

4. The method of claim 1, wherein the molding apparatus comprises a pressure relief valve disposed between an breaker plate and the at least one mold cavity, the pressure relief valve having a predetermined set point at the substantially constant melt pressure and maintaining the substantially constant melt pressure on molten thermoplastic material through the pressure relief valve at a melt pressure higher than the predetermined set point, the pressure relief valve reducing the melt pressure of the thermoplastic material as it passes through the pressure relief valve and enter into the at least one mold cavity.

5. The method of claim 1, wherein the molding apparatus automatically adjusting an extrusion molding process to compensate for variations in the flowability and/or temperature variations of a molten plastic material, the method comprising:
providing an extrusion molding machine with at least one mold cavity;
providing an injection molding controller, which includes a pressure control output that is configured to generate a control signal, which, at least partially determines an extrusion molding pressure and/or temperature for the extrusion molding process of the extrusion molding machine;
measuring a first control signal generated from the pressure control output and/or temperature output at a first time in an extrusion molding cycle;
measuring a second control signal generated from the pressure control output and/or temperature output at a second time in the same extrusion molding cycle, subsequent to the first time;
comparing the first control signal generated from the pressure control output and/or temperature output and the second control signal generated from the pressure control output and/or temperature output to obtain a comparison result; and
determining a third control signal for the pressure control output and/or temperature output, based at least in part on the comparison result, at a third time that is subsequent to the second time.

6. The method of claim 5, wherein the determining includes determining the third control signal at a third time, which is within the same extrusion molding cycle as the second time.

7. The method of claim 5, wherein the third time is located in a subsequent molding cycle from the second time.

8. The method of claim 5, including:
determining a time difference between the first time and the second time; and
wherein the comparing includes comparing the first control signal and the second control signal, based, at least in part, on the time difference, to obtain the comparison result.

9. The method of claim 8, wherein the comparison result is a flow factor (FF) that is used as a soft sensor melt viscosity input to by the controller.

10. The method of claim 9, wherein the FF is determined by the formula:
FF=(CS1-CS2)/T;
where CS1 is the first control signal;
CS2 is the second control signal; and
T is the time difference between CS1 and CS2.

11. The method of claim 10, wherein the third control signal is proportional to the flow factor.

12. The method of claim 10, wherein T is between 0.1 milliseconds and 10 milliseconds.

13. The method of claim 5, wherein the comparison result is used as a basis for a viscosity change index (VCI) that is used as a soft sensor melt viscosity input to by the controller.

14. The method of claim 13, wherein the VCI is determined by the following formula:
VCI=(CS1-CS2)/S
where CS1 is a first control signal;
CS2 is a second control signal; and
S is the position difference for the melt moving machine component.

15. The method of claim 13, wherein the third control signal is proportional to the VCI.

16. The method of claim 13, wherein S is between 0.5 microns and 10 microns.

17. The method of claim 1, wherein the comparing of the first control signal and the second control signal includes comparing the first control signal and the second control signal to optimal control signals based on an optimal pressure curve.

18. The method of claim 5, wherein the providing of the extrusion molding machine includes providing a melt moving machine component; and further comprising:
measuring a first position of the melt moving machine component at the first time;
measuring a second position of the melt moving machine component at the second time;
determining a position difference between the first position and the second position; and
wherein the comparing includes comparing the first control signal and the second control signal, based, at least in part, on the position difference, to obtain the comparison result.

19. The method of claim 5, further comprising controlling the injection molding pressure by sending the third control signal to a melt pressure control device.

20. A controller configured to automatically adjust an extrusion molding process to compensate for variations in the flowability of a molten plastic material, the controller adapted to:
measure a first control signal generated from a pressure control output of the controller at a first time in an extrusion molding cycle using a control signal measurement device;
measure a second control signal generated from the pressure control output of the controller at a second time in the same extrusion molding cycle, subsequent to the first time using the control signal measurement device;
compare the first control signal generated from the pressure control output of the controller and the second control signal generated from the pressure control output of the controller to obtain a comparison result; and
determine a third control signal for the pressure control output, based at least in part on the comparison result, at a third time that is subsequent to the second time.
